(19) United States
(12) Patent Application Publication
(10) Pub. No.: US 2025/0283715 A1
(43) Pub. Date: Sep. 11, 2025

(54) SENSING AND REPORTING GEOMETRIC INFORMATION ASSOCIATED WITH SENSING TARGETS

(71) Applicant: QUALCOMM Incorporated, San Diego, CA (US)

(72) Inventors: Mohammed Ali Mohammed HIRZALLAH, San Marcos, CA (US); Rajat PRAKASH, San Diego, CA (US); Xiaoxia ZHANG, San Diego, CA (US)

(21) Appl. No.: 18/598,984

(22) Filed: Mar. 7, 2024

(51) Int. Cl. G01B 15/04; H04W 24/10

(52) U.S. Cl. CPC G01B 15/04; H04W 24/10

(57) ABSTRACT

Methods, systems, and devices for wireless communication are described. A wireless device may receive, from a network entity, control signaling that indicates a configuration for sensing and reporting information of a target entity in a wireless communication system. The wireless device may obtain geometric information (e.g., shape, dimension, and the like) associated with the target entity in the wireless communication system based on a radio frequency (RF) sensing procedure according to the configuration. The wireless device may transmit, to the network entity, a report including the geometric information associated with the target entity.

### FIELD OF TECHNOLOGY

The following relates to wireless communication, including sensing and reporting geometric information associated with sensing targets.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sensing and reporting geometric information associated with sensing targets.

A method for wireless communications by a wireless device is described. The method may include receiving, from a network entity, control signaling including a configuration for sensing and reporting information of a target entity in a wireless communication system, obtaining geometric information associated with the target entity in the wireless communication system based on a radio frequency (RF) sensing procedure according to the configuration, and transmitting, to the network entity, a report including the geometric information associated with the target entity.

A wireless device for wireless communications is described. The wireless device may include one or more memories storing processor executable code, and one or more processors coupled with the one or more memories. The one or more processors may individually or collectively be operable to execute the code to cause the wireless device to receive, from a network entity, control signaling including a configuration for sensing and reporting information of a target entity in a wireless communication system, obtain geometric information associated with the target entity in the wireless communication system based on an RF sensing procedure according to the configuration, and transmit, to the network entity, a report including the geometric information associated with the target entity.

Another wireless device for wireless communications is described. The wireless device may include means for receiving, from a network entity, control signaling including a configuration for sensing and reporting information of a target entity in a wireless communication system, means for obtaining geometric information associated with the target entity in the wireless communication system based on an RF sensing procedure according to the configuration, and means for transmitting, to the network entity, a report including the geometric information associated with the target entity.

A non-transitory computer-readable medium storing code for wireless communications is described. The code may include instructions executable by one or more processors to receive, from a network entity, control signaling including a configuration for sensing and reporting information of a target entity in a wireless communication system, obtain geometric information associated with the target entity in the wireless communication system based on an RF sensing procedure according to the configuration, and transmit, to the network entity, a report including the geometric information associated with the target entity.

Some examples of the method, wireless devices, and non-transitory computer-readable medium described herein may further include operations, features, means, or instructions for identifying expected geometric information associated with the target entity based on the configuration, the expected geometric information including one or more of an expected shape associated with the target entity or an expected dimension associated with the target entity, and where the RF sensing procedure may be based on the expected geometric information associated with the target entity.

In some examples of the method, wireless devices, and non-transitory computer-readable medium described herein, the expected geometric information corresponds to at least one format of indicating one or more of the expected shape associated with the target entity or the expected dimension associated with the target entity and the expected geometric information includes one or more of bounding box information or bounding sphere information indicative of one or more of the expected shape associated with the target entity or the expected dimension associated with the target entity.

Some examples of the method, wireless devices, and non-transitory computer-readable medium described herein may further include operations, features, means, or instructions for identifying resolution information for sensing the target entity based on the configuration, where the resolution information includes a preferred beam-range resolution indicating one or more of a preferred beam range or a preferred beam azimuth, and where the RF sensing procedure may be based on the resolution information for sensing the target entity.

Some examples of the method, wireless devices, and non-transitory computer-readable medium described herein may further include operations, features, means, or instructions for identifying at least one report format of the report including the geometric information associated with the target entity based on the configuration, the report including the geometric information associated with the target entity may be based on the at least one report format.

Some examples of the method, wireless devices, and non-transitory computer-readable medium described herein may further include operations, features, means, or instructions for receiving, from the network entity, a first request message for first geometric information associated with the target entity, obtaining the first geometric information associated with the target entity based on the RF sensing procedure and a first set of parameters associated with the configuration, and transmitting, to the network entity, a first response message including the first geometric information associated with the target entity based on the first request message for the first geometric information associated with the target entity.

Some examples of the method, wireless devices, and non-transitory computer-readable medium described herein may further include operations, features, means, or instructions for receiving, from the network entity, a second request message for second geometric information associated with the target entity based on the first response message including the first geometric information associated with the target entity, obtaining the second geometric information associated with the target entity based on the RF sensing procedure and a second set of parameters associated with the configuration, where the second set of parameters may be different than the first set of parameters, and transmitting, to the network entity, a second response message including the second geometric information associated with the target entity based on the second request message for the second geometric information associated with the target entity.

In some examples of the method, wireless devices, and non-transitory computer-readable medium described herein, the geometric information includes one or more of the first geometric information associated with the target entity or the second geometric information associated with the target entity.

Some examples of the method, wireless devices, and non-transitory computer-readable medium described herein may further include operations, features, means, or instructions for receiving, from the network entity, the control signaling including a set of multiple hypotheses configurations for sensing the target entity, where each hypothesis configuration of the set of multiple hypotheses configurations for sensing the target entity includes a set of parameters, and where the set of parameters indicates one or more of a sensing procedure for sensing the target entity, a center frequency associated with sensing the target entity, or a bandwidth associated with sensing the target entity, obtaining a set of multiple geometric information associated with the target entity based on the set of multiple hypotheses configurations for sensing the target entity, assigning a corresponding quality score for each geometric information of the set of multiple geometric information, and transmitting, to the network entity, the report including the set of multiple geometric information associated with the target entity and assigned corresponding quality score for each corresponding geometric information of the set of multiple geometric information.

In some examples of the method, wireless devices, and non-transitory computer-readable medium described herein, the corresponding quality score indicates a probability of each geometric information of the set of multiple geometric information associated with the target entity or a confidence of each geometric information of the set of multiple geometric information associated with the target entity.

Some examples of the method, wireless devices, and non-transitory computer-readable medium described herein may further include operations, features, means, or instructions for transmitting, to the network entity, capability information associated with the wireless device for sensing the target entity, where receiving, from the network entity, the control signaling including the configuration may be based on transmitting, to the network entity, the capability information associated with the wireless device for sensing the target entity.

Some examples of the method, wireless devices, and non-transitory computer-readable medium described herein may further include operations, features, means, or instructions for receiving, from the network entity, a request message for the capability information associated with the wireless device for sensing the target entity, where transmitting, to the network entity, the capability information may be based on receiving, from the network entity, the request message for the capability information associated with the wireless device for sensing the target entity.

Some examples of the method, wireless devices, and non-transitory computer-readable medium described herein may further include operations, features, means, or instructions for obtaining one or more measurement values associated with the target entity based on the RF sensing procedure, determining assistance information based on the one or more measurement values associated with the target entity, where the assistance information includes one or more of an expected shape associated with the target entity or an expected dimension associated with the target entity, and transmitting, to the network entity, an indication of at least one of the one or more measurement values or the assistance information associated with the target entity.

In some examples of the method, wireless devices, and non-transitory computer-readable medium described herein, the wireless device includes a UE or a transmission-reception point (TRP).

In some examples of the method, wireless devices, and non-transitory computer-readable medium described herein, the network entity includes a network entity including one or more of a location management function (LMF) or a sensing management function (SnMF).

In some examples of the method, wireless devices, and non-transitory computer-readable medium described herein, the control signaling includes a system information block (SIB) and the SIB includes a position SIB (posSIB) or a sensing SIB (senseSIB).

A method for wireless communications by a network entity is described. The method may include transmitting, to a wireless device, control signaling including a configuration for sensing and reporting information of a target entity in a wireless communication system and receiving, from the wireless device, a report including geometric information associated with the target entity based on the configuration for sensing and reporting information of the target entity.

A network entity for wireless communications is described. The network entity may include one or more memories storing processor executable code, and one or more processors coupled with the one or more memories. The one or more processors may individually or collectively be operable to execute the code to cause the network entity to transmit, to a wireless device, control signaling including a configuration for sensing and reporting information of a target entity in a wireless communication system and receive, from the wireless device, a report including geometric information associated with the target entity based on the configuration for sensing and reporting information of the target entity.

Another network entity for wireless communications is described. The network entity may include means for transmitting, to a wireless device, control signaling including a configuration for sensing and reporting information of a target entity in a wireless communication system and means for receiving, from the wireless device, a report including geometric information associated with the target entity based on the configuration for sensing and reporting information of the target entity.

A non-transitory computer-readable medium storing code for wireless communications is described. The code may include instructions executable by one or more processors to transmit, to a wireless device, control signaling including a configuration for sensing and reporting information of a target entity in a wireless communication system and receive, from the wireless device, a report including geometric information associated with the target entity based on the configuration for sensing and reporting information of the target entity.

In some examples of the method, network entities, and non-transitory computer-readable medium described herein, the configuration identifies expected geometric information associated with the target entity and the expected geometric information includes one or more of an expected shape associated with the target entity or an expected dimension associated with the target entity.

In some examples of the method, network entities, and non-transitory computer-readable medium described herein, the expected geometric information corresponds to at least one format of indicating one or more of the expected shape associated with the target entity or the expected dimension associated with the target entity and the expected geometric information includes one or more of bounding box information or bounding sphere information indicative of one or more of the expected shape associated with the target entity or the expected dimension associated with the target entity.

In some examples of the method, network entities, and non-transitory computer-readable medium described herein, the configuration identifies resolution information for sensing the target entity and the resolution information includes a preferred beam-range resolution indicating one or more of a preferred beam range or a preferred beam azimuth.

In some examples of the method, network entities, and non-transitory computer-readable medium described herein, the configuration identifies at least one report format of the report including the geometric information associated with the target entity based on the configuration.

Some examples of the method, network entities, and non-transitory computer-readable medium described herein may further include operations, features, means, or instructions for transmitting, to the wireless device, a first request message for first geometric information associated with the target entity and receiving, from the wireless device, a first response message including the first geometric information associated with the target entity based on the first request message for the first geometric information associated with the target entity.

Some examples of the method, network entities, and non-transitory computer-readable medium described herein may further include operations, features, means, or instructions for transmitting, to the wireless device, a second request message for second geometric information associated with the target entity based on the first response message including the first geometric information associated with the target entity and receiving, from the wireless device, a second response message including the second geometric information associated with the target entity based on the second request message for the second geometric information associated with the target entity.

In some examples of the method, network entities, and non-transitory computer-readable medium described herein, the geometric information includes one or more of the first geometric information associated with the target entity or the second geometric information associated with the target entity.

Some examples of the method, network entities, and non-transitory computer-readable medium described herein may further include operations, features, means, or instructions for transmitting, to the wireless device, the control signaling including a set of multiple hypotheses configurations for sensing the target entity, where each hypothesis configuration of the set of multiple hypotheses configurations for sensing the target entity includes a set of parameters, and where the set of parameters indicates one or more of a sensing procedure for sensing the target entity, a center frequency associated with sensing the target entity, or a bandwidth associated with sensing the target entity and receiving, from the wireless device, the report including a set of multiple geometric information associated with the target entity and assigned corresponding quality score for each corresponding geometric information of the set of multiple geometric information.

In some examples of the method, network entities, and non-transitory computer-readable medium described herein, the assigned corresponding quality score indicates a probability of each geometric information of the set of multiple geometric information associated with the target entity or a confidence of each geometric information of the set of multiple geometric information associated with the target entity.

Some examples of the method, network entities, and non-transitory computer-readable medium described herein may further include operations, features, means, or instructions for receiving, from the wireless device, capability information associated with the wireless device for sensing the target entity and where transmitting, to the wireless device, the control signaling including the configuration may be based on receiving, from the wireless device, the capability information associated with the wireless device for sensing the target entity.

Some examples of the method, network entities, and non-transitory computer-readable medium described herein may further include operations, features, means, or instructions for transmitting, to the wireless device, a request message for the capability information associated with the wireless device for sensing the target entity and where receiving, from the wireless device, the capability information may be based on transmitting, to the wireless device, the request message for the capability information associated with the wireless device for sensing the target entity.

Some examples of the method, network entities, and non-transitory computer-readable medium described herein may further include operations, features, means, or instructions for receiving, from the wireless device, an indication of one or more of one or more measurement values or assistance information associated with the target entity.

In some examples of the method, network entities, and non-transitory computer-readable medium described herein, the wireless device includes a UE or a TRP.

In some examples of the method, network entities, and non-transitory computer-readable medium described herein, the network entity includes a network entity including one or more of an LMF or an SnMF.

In some examples of the method, network entities, and non-transitory computer-readable medium described herein, the control signaling includes an SIB and the SIB includes a posSIB or a senseSIB.

### BRIEF DESCRIPTION OF THE DRAWINGS

FIGS. 1 and 2 show examples of wireless communications systems that support sensing and reporting geometric information associated with sensing targets in accordance with one or more aspects of the present disclosure.

FIGS. 3 through 7 show flowcharts illustrating methods that support sensing and reporting geometric information associated with sensing targets in accordance with one or more aspects of the present disclosure.

FIG. 8 shows an example of a process flow that supports sensing and reporting geometric information associated with sensing targets in accordance with one or more aspects of the present disclosure.

FIGS. 9 and 10 show block diagrams of devices that support sensing and reporting geometric information associated with sensing targets in accordance with one or more aspects of the present disclosure.

FIG. 11 shows a block diagram of a communications manager that supports sensing and reporting geometric information associated with sensing targets in accordance with one or more aspects of the present disclosure.

FIG. 12 shows a diagram of a system including a device that supports sensing and reporting geometric information associated with sensing targets in accordance with one or more aspects of the present disclosure.

FIGS. 13 and 14 show block diagrams of devices that support sensing and reporting geometric information associated with sensing targets in accordance with one or more aspects of the present disclosure.

FIG. 15 shows a block diagram of a communications manager that supports sensing and reporting geometric information associated with sensing targets in accordance with one or more aspects of the present disclosure.

FIG. 16 shows a diagram of a system including a device that supports sensing and reporting geometric information associated with sensing targets in accordance with one or more aspects of the present disclosure.

FIGS. 17 and 18 show flowcharts illustrating methods that support sensing and reporting geometric information associated with sensing targets in accordance with one or more aspects of the present disclosure.

### DETAILED DESCRIPTION

A wireless device may support RF sensing, in which the wireless device and one or more sensing nodes may transmit a signal and receive reflected signals from a target entity (e.g., object, device). Geometric information, such as a shape or one or more dimensions of the target entity, may be key information for the wireless device to acquire in order to perform operations such as target classification or digital reconstruction of the target entity. However, obtaining and reporting geometric information poses challenges. In some cases, the wireless device may lack awareness of the sensing resolution parameters for sensing the target entity leading to ineffective or inaccurate sensing. Alternatively, there are cases where the wireless device and one or more sensing nodes are unaware of the appropriate format for reporting geometric information. Addressing these and other challenges may be desirable for applications related to RF sensing, specifically in the context of obtaining and reporting of geometric information.

Various aspects of the present disclosure relate to enabling a wireless device to be configured with a configuration for RF sensing, and specifically one or more parameters for obtaining geometric information (e.g., shape, dimension, and the like) of a target entity (e.g., device, object) in an environment and reporting the obtained geometric information to a network entity (e.g., a location management function (LMF) or a sensing management function (SnMF) of a sensing server). The configuration may include expected geometric information (e.g., expected shape, expected dimension) associated with the target entity. The wireless device may perform an RF sensing procedure for sensing the target based on the expected geometric information (e.g., expected shape, expected dimension) associated with the target entity. In some examples, the configuration may also include resolution information for sensing the target entity. The resolution information may indicate preferred resolution sensing parameters for sensing the target entity (e.g., a beam range associated with a set of one or more sensing beams, a beam azimuth associated with at least one sensing beam). Additionally, or alternatively, the configuration may include at least one report format (e.g., .fbx, .3ds, .obj, or the like) for reporting the geometric information associated with the target entity to the network entity.

Aspects of the disclosure are initially described in the context of wireless communications systems. Aspects of the disclosure are further illustrated by and described with reference to apparatus diagrams, system diagrams, and flowcharts that relate to sensing and reporting geometric information associated with sensing targets.

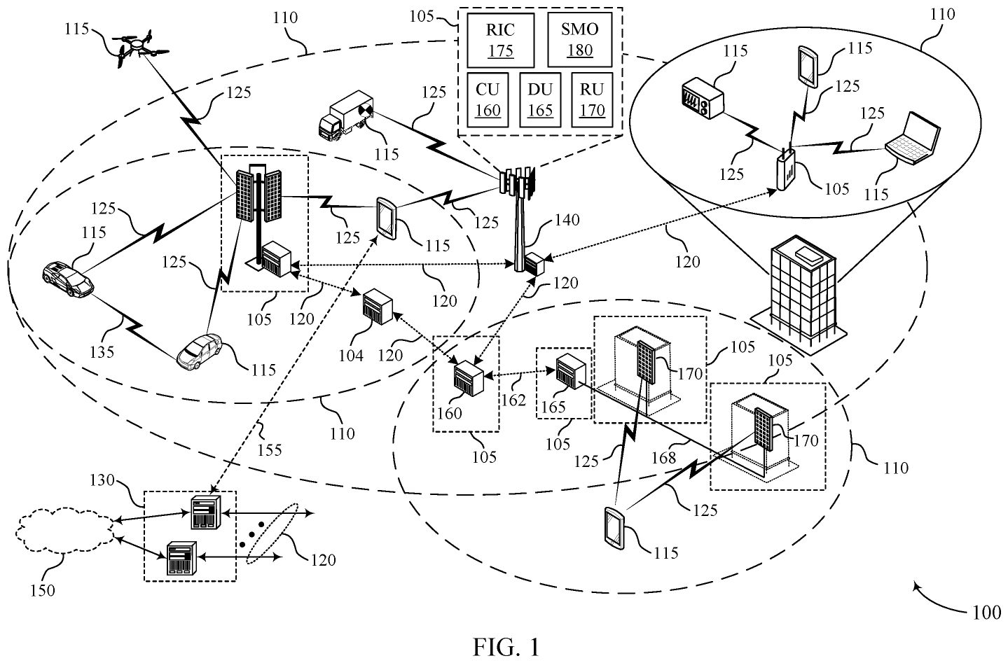

FIG. 1 shows an example of a wireless communications system 100 that supports sensing and reporting geometric information associated with sensing targets in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission-reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 including one or more network entities 105, one or more UEs 115, or one or more base station 140 may support RF sensing of a target entity. A wireless signal may be transmitted from one or multiple transmission nodes (also referred to as transmit points) and received at one or multiple reception nodes (also referred to as receive points) after being reflected off the target entity. One or more network entities 105, one or more UEs 115, or one or more base station 140 may obtain (e.g., detect) geometric information (e.g., shape, dimension, and the like) associated with the target entity for various applications, for example, for classifying the target entity, identifying the target entity, reconstructing a digital version of the target entity or an environment associated with the target entity, or the like.

Some examples of applications for RF sensing may include, but is not limited to, transportation applications (e.g., intrusion detection on a highway, sensing assisted automotive maneuvering and navigation, smart parking and assistance, etc.), unmanned aerial vehicle (UAV) applications (e.g., UAV flight trajectory tracing, sensing for UAV intrusion detection, etc.), smart city applications (e.g., rainfall monitoring, tourist spot traffic management, flooding awareness, weather forecasting, public safety search and rescue, etc.), smart home applications (e.g., intruder detection in a smart home, gesture recognition, extended reality (XR) streaming), health monitoring applications (e.g., monitoring vital signs and health related measures, sleep and health monitoring, etc.), and smart factory applications (e.g., automated guided vehicle (AGV) detection and tracking in factories, etc.), among other examples

Obtaining geometric information associated with a target entity may be based on one or multiple parameters (also referred to as sensing key performance indicators (KPIs)). One or more examples of these parameters may include, but is not limited to, an accuracy of positioning (e.g., horizontal, vertical) associated with the target entity, an accuracy of a range or cross-range associated with the target entity, an accuracy of an angle-of-arrival (AoA) associated with the target entity, an accuracy of velocity (e.g., horizontal, vertical) associated with the target entity, a sensing range or sensing cross-range resolution, a sensing velocity resolution, a sensing angle resolution, a sensing refreshing rate, a receiver operating characteristic (ROC) (e.g., misdetection and false alarm probabilities), a confidence interval of RF sensing associated with the target entity, a target discrimination, among other examples.

In some cases, obtaining geometric information associated with the target entity may impose use of appropriate resolution information (e.g., sensing resolution sensing parameters), which may be dependent on an actual shape (e.g., size) associated with the target entity or an actual dimension associated with the target entity. For meter or submeter dimensions, for example, the resolution information (e.g., sensing resolution sensing parameters) may be smaller than a dimension associated with the target entity, so that the one or more network entities 105, one or more UEs 115, or one or more base station 140 may detect the actual shape (e.g., size) associated with the target entity.

In some other cases, reporting of obtained geometric information associated with the target entity may be challenging because of a lack of a format supported by sensing nodes and sensing servers in the wireless communications system 100. For example, one or more network entities 105, one or more UEs 115, or one or more base station 140 may lack support for a format associated with reporting of obtained geometric information associated with the target entity.

In other cases, reporting of obtained geometric information associated with the target entity may be challenging because one or more network entities 105, one or more UEs 115, or one or more base station 140 may lack efficient reporting obtained geometric information (e.g., shape, dimension). For example, reporting of obtained geometric information associated with the target entity may relate to high signaling overhead depending on resolution information and may consume significant over-the-air (OTA) resources associated with reporting of obtained geometric information.

In some other cases, obtaining geometric information associated with the target entity may be challenging, specifically, obtaining geometric information (e.g., shape, size, dimension, and the like) with a high accuracy because a beam-range map may be noisy and subject to clutter, which may result in low accuracy or uncertainty of the obtained geometric information associated with the target entity.

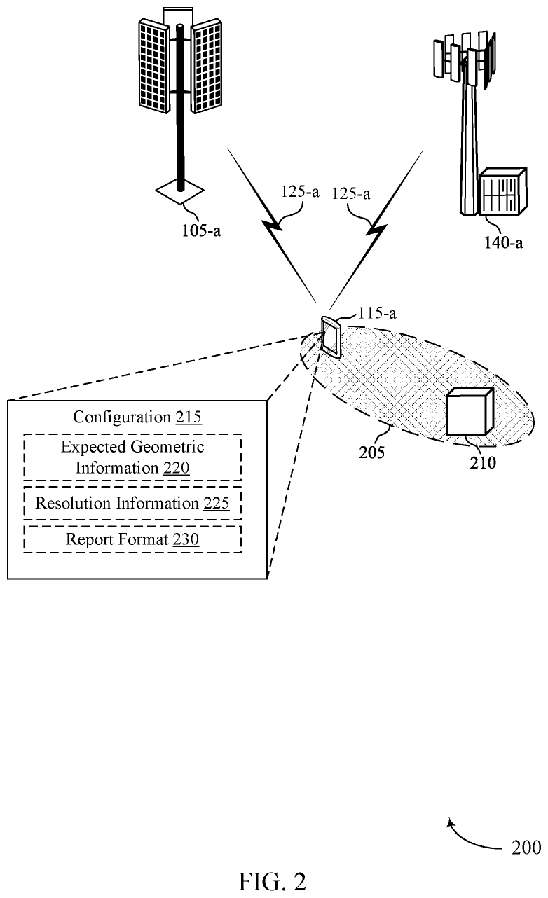

In the example of FIG. 1, the wireless communications system 100, including one or more network entities 105, one or more UEs 115, or one or more base station 140 may address the challenges above by enabling one or more network entities 105 (e.g., sensing servers, such as LMF, SnMF), one or more UEs 115 (e.g., TRPs), or one or more base station 140 (e.g., sensing servers, such as LMF, SnMF) to support efficient RF sensing of one or more target entities and reporting of geometric information (e.g., shape, size, dimension, and the like) associated with the one or more target entities as described in more detail with reference to FIGS. 2 through 8.

FIG. 2 shows an example of a wireless communications system 200 that supports sensing and reporting geometric information associated with sensing targets in accordance with one or more aspects of the present disclosure. In some examples, the wireless communications system 200 may implement or be implemented by aspects of the wireless communications system 100 as described herein with reference to FIG. 1. For example, the wireless communications system 200 may include a network entity 105-a, a UE 115-a, and a base station 140-a, which may be an example of a network entity 105, a UE 115, and a base station 140 as described herein with reference to FIG. 1. The wireless communications system 200 may support multiple radio access technologies including 4G LTE, 5G NR, or a combination thereof. For example, the network entity 105-a may support one or more radio access technologies, such as 4G LTE or 5G NR. The UE 115-a may support one or more radio access technologies, such as 4G LTE or 5G NR. The base station 140-a may support one or more radio access technologies, such as 4G LTE or 5G NR. It should be noted that the wireless communications system 200 may support radio access technologies beyond 5G NR.

In the example of FIG. 2, the wireless communications system 200 including one or more of the network entity 105-a, the UE 115-a, or the base station 140-a may support RF sensing. For example, the UE 115-a may support performing an RF sensing procedure 205 of a target entity 210. A target entity may be a target object or a target device in the wireless communications system 200. The UE 115-a may receive, from one or more of the network entity 105-a or the base station 140-a via a communication link 125-a, control signaling that includes a configuration 215 for sensing and reporting information of the target entity 210 in the wireless communications system 200. One or more of the network entity 105-a or the base station 140-a may be an LMF or a SnMF, which may transmit, to the UE 115-a, the control signaling that includes the configuration 215 for sensing and reporting information of the target entity 210. In some examples, the control signaling may include a SIB, which may be a position SIB (posSIB) or a sensing SIB (senseSIB). A posSIB may include assistance information (also referred to as assistance data) to support positioning of the target entity 210. A senseSIB may include assistance information (also referred to as assistance data) to support sensing of the target entity 210. The assistance information of one or more of the posSIB or the senseSIB may include one or more parameters, such as at least one parameter that indicates whether the assistance information for one or more of the posSIB or the senseSIB is valid, at least one parameter that indicates a duration that the assistance information for one or more of the posSIB or the senseSIB is valid. Additionally, or alternatively, the assistance information may include geometric information associated with the target entity 210, a sensing procedure for sensing the target entity 210, a center frequency associated with sensing the target entity 210, or a bandwidth associated with sensing the target entity 210, among other examples as described herein. Thus, as described herein, signaling of configurations and assistance information may be provided through SIB. For example, one or more of the network entity 105-a or the base station 140-a may broadcast to the UE 115-a one or more of a posSIB or a senseSIB, which may include assistance information to support one or more of positioning or sensing of the target entity 210.

One or more of the network entity 105-a, the UE 115-a, or the base station 140-a may exchange capability information that indicates capabilities to conduct sensing of geometric information (e.g., shape, dimension) associated with the target entity 210. The exchange of capability information by the UE 115-a may be based on a request, for example, from one or more of the network entity 105-a or the base station 140-a. The UE 115-a may obtain geometric information associated with the target entity 210 based on performing the RF sensing procedure 205 and according to the configuration 215. In some examples, one or more of the network entity 105-a, the UE 115-a, or the base station 140-a may support various modes of RF sensing, which may include a monostatic mode or a bi-static mode (also referred to as multi-static mode). Under the monostatic mode, one or more of the network entity 105-a, the UE 115-a, or the base station 140-a may be located at a same location as the target entity 210, and as a result, one or more of the network entity 105-a, the UE 115-a, or the base station 140-a may perform the RF sensing procedure 205 to detect the target entity 210 and obtain geometric information associated with the target entity 210. Put another way, the network entity 105-a, the UE 115-a, and the base station 140-a may perform the RF sensing procedure 205 by transmitting signals and receiving reflected signals from the target entity 210. Under the bi-static mode, one or more of the network entity 105-a or the UE 115-a may be located at separate locations from the target entity 210, and as a result, one or more of the network entity 105-a or the UE 115-a may perform the RF sensing procedure 205 to detect the target entity 210 and obtain geometric information associated with the target entity 210. Put another way, at least one of the network entity 105-a, the UE 115-a, or the base station 140-a may transmit signals towards the target entity 210, while at least one other of the network entity 105-a, the UE 115-a, or the base station 140-a may receive reflected signals from the target entity 210 for RF sensing the target entity 210.

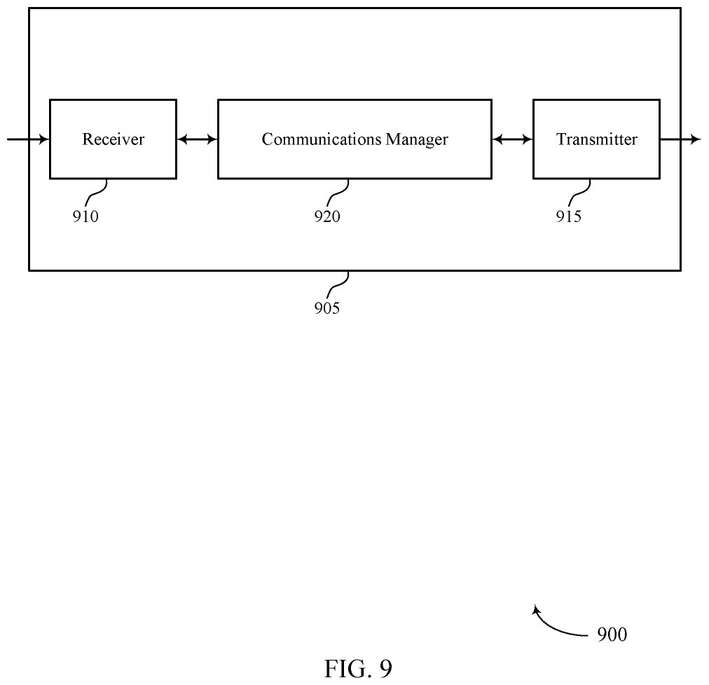

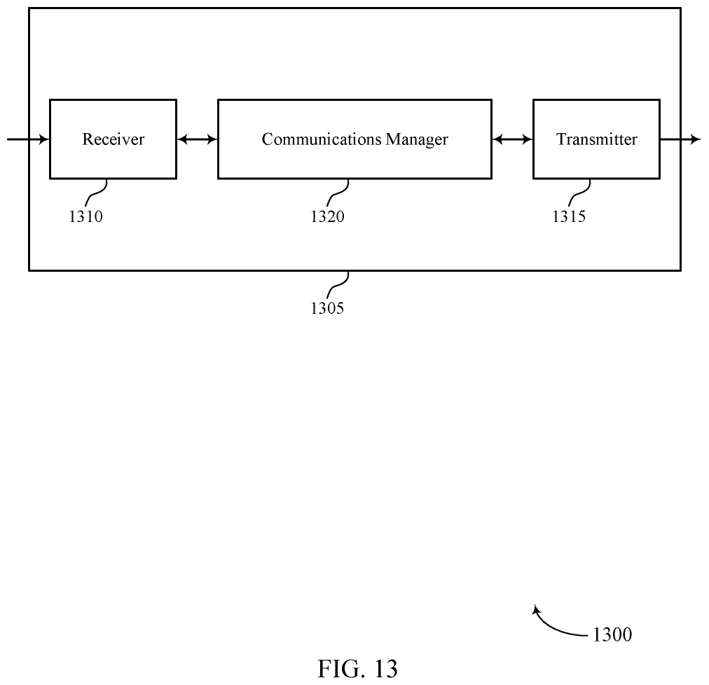

By way of example, in the wireless communications system 200, the UE 115-a may be equipped with one or more RF transmitters (as described with reference to FIGS. 9 through 12) configured to emit RF signals during the RF sensing procedure 205, and one or more RF receivers (as described with reference to FIGS. 9 through 12) configured to detect reflections of the emitted RF signals during the RF sensing procedure 205. The RF signals are transmitted into the environment using the one or more RF transmitters of the UE 115-a. Upon encountering the target entity 210 within the environment, the RF signals are partially reflected back towards the UE 115-a, including the one or more RF receivers of the UE 115-a. The reflected signals are then captured and processed to obtain or determine information about the target entity 210 as described herein. Additionally, or alternatively, one or both of the network entity 105-a or the base station 140-a may be equipped with one or more RF transmitters (as described with reference to FIGS. 13 through 16) configured to emit RF signals during the RF sensing procedure 205, and one or more RF receivers (as described with reference to FIGS. 13 through 16) configured to detect reflections of the emitted RF signals during the RF sensing procedure 205. The RF signals are transmitted into the environment using the one or more RF transmitters of one or both of the network entity 105-a or the base station 140-a. Upon encountering the target entity 210 within the environment, the RF signals are partially reflected back towards one or both of the network entity 105-a or the base station 140-a, including the one or more RF receivers of one or both of the network entity 105-a or the base station 140-a. The reflected signals are then captured and processed to obtain or determine information about the target entity 210 as described herein.

The UE 115-a may identify expected geometric information 220 associated with the target entity 210 based on the configuration 215. The expected geometric information 220 may include one or more of an expected shape associated with the target entity 210 or an expected dimension associated with the target entity 210. Additionally, or alternatively, the UE 115-a may identify resolution information 225 for sensing the target entity 210 based on the configuration 215. The resolution information 225 may include a preferred beam-range resolution indicating one or more of a preferred beam range or a preferred beam azimuth for sensing the target entity 210. A preferred beam range may define one or more of a beam diameter or a beam radius, which may be associated with a direction of propagation of a beamformed RF signal. A preferred beam azimuth may define an angle or direction (e.g., in degrees) of a beamformed RF signal with respect to a reference point. Alternatively, the UE 115-a may determine or select a set of one or more sensing resolution parameters (e.g., beam-range resolution, beam azimuth) for obtaining geometric information (e.g., shape, dimension) associated with the target entity 210 based on one or more of the expected geometric information 220 associated with the target entity 210.

Put another way, a sensing node (e.g., the UE 115-a) may receive, from a sensing server (e.g., one or more of the network entity 105-a or the base station 140-a) an indication of the expected geometric information 220 (e.g., expected size, expected dimension) associated with the target entity 210. The sensing node (e.g., the UE 115-a) may select a set of one or more sensing resolution parameters appropriate for detecting (e.g., obtaining) the geometric information (e.g., size, dimension) associated with the target entity 210. Alternatively, the sensing node (e.g., the UE 115-a) may receive, from the sensing server (e.g., one or more of the network entity 105-a or the base station 140-a), an indication of a preferred set one or more sensing resolution parameters appropriate for detecting (e.g., obtaining) the geometric information (e.g., size, dimension) associated with the target entity 210.

The UE 115-a may transmit, to one or more of the network entity 105-a or the base station 140-a via a communication link 125-a, report including the geometric information associated with the target entity 210. Additionally, or alternatively, the UE 115-a may identify at least one report format 230 for reporting geometric information associated with the target entity 210 based on the configuration 215. Put another way, a sensing node (e.g., the UE 115-a) may transmit, to a sensing server (e.g., one or more of the network entity 105-a or the base station 140-a), a report including the geometric information associated with the target entity 210 according to the at least one report format 230 for reporting geometric information associated with the target entity 210. In some examples, the at least one report format 230 may be associated with a set of report formats, and the at least one report format 230 may be identified based on an index associated with the at least one report format 230. The index associated with the at least one report format 230 may correspond to one or more categories or ranges associated with geometric information (e.g., shape, size, dimension). Additionally, or alternatively, the at least one report format 230 may correspond to one or more of a two-dimensional (2D) format or three-dimensional (3D) format, which may include, but is not limited to, one or more data file formats, such as .shp, .shx, .dbf, .sbn, .fbn, and the like. In other examples, the report formats may include, but is not limited to, other data file formats, such as .fbx, .3ds, .obj, .stl, stp, .dae, .3MF, .usdz, .usd, .gltf, .glb, .iges, .blend, and the like.

Additionally, or alternatively, the UE 115-a may identify a granularity for reporting geometric information associated with the target entity 210 based on the configuration 215. For example, the UE 115-a may support incremental reporting of geometric information associated with the target entity 210. In some examples, the UE 115-a may report higher resolution geometric information (e.g., shape, size, dimension) associated with the target entity 210 incrementally based on a request from one or more of the network entity 105-a or the base station 140-a. Put another way, a sensing node (e.g., the UE 115-a) may initially report lower resolution geometric information (e.g., shape, size, dimension) and then subsequently report deltas based on requests from a sensing server (e.g., one or more of the network entity 105-a or the base station 140-a). In some examples, the sensing node (e.g., the UE 115-a) may report multiple estimates of geometric information (e.g., estimated shape, estimated dimension) of the target entity 210, wherein the obtained estimates of geometric information may be based on a same set of one or more sensing resolution parameters. The set of one or more sensing resolution parameters may include one or more of a sensing procedure for sensing the target entity 210, a center frequency associated with sensing the target entity 210, or a bandwidth associated with sensing the target entity 210.

It should be understood that the UE 115-a may provide raw data and assistance information associated with geometric information (e.g., size, shape, dimension) of the target entity 210 to one or more of the network entity 105-a or the base station 140-a to support RF sensing of the target entity 210 by one or more of the network entity 105-a or the base station 140-a. Put another way, a sensing node (e.g., the UE 115-a) may provide assistance information to a sensing server (e.g., one or more of the network entity 105-a or the base station 140-a) to assist the sensing server in determining (e.g., computing, calculating) the geometric information (e.g., size, shape, dimension) of the target entity 210. Additionally or alternatively, the sensing server (e.g., one or more of the network entity 105-a or the base station 140-a) may request and receive capabilities, provide configurations/assistance data, and receive reporting of geometric information associated with the target entity 210.

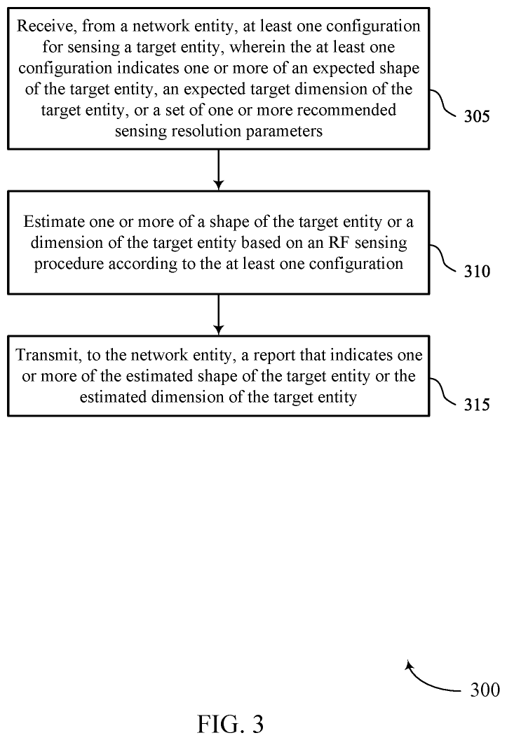

FIG. 3 shows an example of a method 300 that supports sensing and reporting geometric information associated with sensing targets in accordance with one or more aspects of the present disclosure. The operations of the method 300 may be implemented by a wireless device (e.g., a UE or a TRP) or its components as described herein. For example, the operations of the method 300 may be performed by a UE 115 as described with reference to FIGS. 1 and 2. In some examples, a wireless device may execute a set of instructions to control the functional elements of the wireless device to perform the described functions. Additionally, or alternatively, the wireless device may perform aspects of the described functions using special-purpose hardware.

At 305, the method may include receiving, from a network entity, at least one configuration for sensing a target entity, wherein the at least one configuration indicates one or more of an expected shape of the target entity, an expected dimension of the target entity, or a set of one or more recommended sensing resolution parameters. The network entity may be an example of a network entity 105 as described with reference to FIGS. 1 and 2. The target entity may be an example of a target entity 210 as described with reference to FIG. 2. For example, the wireless device (e.g., a UE, a TRP) may receive, from a network entity 105 (e.g., an LMF, an SnMF), one or more configurations (e.g., resolution configurations) for sensing one or more of a shape or a dimension of a target entity 210. In some examples, one or more of the expected shape of the target entity 210 or the expected dimension of the target entity 210 may be indicated (e.g., reported) according to a shape/object format (e.g., .fbx, .3ds, .obj, .stl, .stp, .dae, .3mf, .usdz, .usd, .gltf, .glb, .iges, .blend). In some other examples, one or more of the expected shape of the target entity 210 or the expected dimension of the target entity 210 may be indicated (e.g., reported) according to one or more of bounding box information or bounding sphere information. A bounding box may refer to a geometrical box shape that encapsulates (e.g., surrounds, includes, contains) an object, such as the target entity 210, for sensing the target entity 210. The bounding box may be defined by a set of coordinates (e.g., minimum and maximum coordinates in one or more directions (e.g., axis) to form the bounding box in a multidimensional space (e.g., 2D, 3D). A bonding sphere may also refer to a geometrical sphere shape that encapsulates (e.g., surrounds, includes, contains) an object, such as the target entity 210, for sensing the target entity 210. The bounding sphere may be defined by a set of coordinates (e.g., minimum and maximum coordinates in one or more directions (e.g., axis) to form the bounding sphere in a multidimensional space (e.g., 2D, 3D). In other examples, the set of one or more recommended sensing resolution parameters may be indicated, for example, such as beam-range resolution, beam azimuth, or the like). The operations may be performed in accordance with examples as disclosed herein.

At 310, the method may include estimating one or more of a shape of the target entity or a dimension of the target entity based on an RF sensing procedure according to the at least one configuration. The target entity may be an example of a target entity 210 as described with reference to FIG. 2. For example, the wireless devices may perform (e.g., conduct) an RF sensing according to the at least one configuration, in which the wireless device may detect one or more of the shape of the target entity 210 or the dimension of the target entity 210. The operations may be performed in accordance with examples as disclosed herein.

At 315, the method may include transmitting, to the network entity, a report that indicates one or more of the estimated shape of the target entity or the estimated dimension of the target entity. The network entity may be an example of a network entity 105 as described with reference to FIGS. 1 and 2. The target entity may be an example of a target entity 210 as described with reference to FIG. 2. For example, the wireless devices may report information (e.g., shape, dimension of the target entity) to the network entity 105 (e.g., the LMF, the SnMF). The operations may be performed in accordance with examples as disclosed herein.

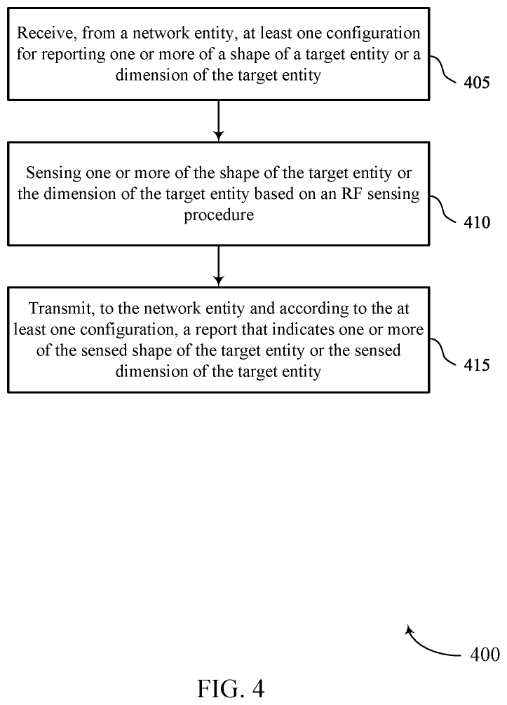

FIG. 4 shows an example of a method 400 that supports sensing and reporting geometric information associated with sensing targets in accordance with one or more aspects of the present disclosure. The operations of the method 400 may be implemented by a wireless device (e.g., a UE or a TRP) or its components as described herein. For example, the operations of the method 400 may be performed by a UE 115 as described with reference to FIGS. 1 and 2. In some examples, a wireless device may execute a set of instructions to control the functional elements of the wireless device to perform the described functions. Additionally, or alternatively, the wireless device may perform aspects of the described functions using special-purpose hardware.

At 405, the method may include receiving, from a network entity, at least one configuration for reporting one or more of a shape of a target entity or a dimension of the target entity. The network entity may be an example of a network entity 105 as described with reference to FIGS. 1 and 2. The target entity may be an example of a target entity 210 as described with reference to FIG. 2. For example, the wireless device may (e.g., a UE, a TRP) may receive, from a network entity 105 (e.g., an LMF, a SnMF), one or more configurations for reporting one or more of the shape of a target entity 210 or the dimension of the target entity 210. The operations may be performed in accordance with examples as disclosed herein.

At 410, the method may include sensing one or more of the shape of the target entity or the dimension of the target entity based on an RF sensing procedure. The target entity may be an example of a target entity 210 as described with reference to FIG. 2. For example, the wireless device may perform (e.g., conduct) RF sensing, in which the wireless device may detect one or more of the shape of the target entity 210 or the dimension of the target entity 210. The operations may be performed in accordance with examples as disclosed herein.

At 415, the method may include transmitting, to the network entity and according to the at least one configuration, a report that indicates one or more of the sensed shape of the target entity or the sensed dimension of the target entity. The network entity may be an example of a network entity 105 as described with reference to FIGS. 1 and 2. The target entity may be an example of a target entity 210 as described with reference to FIG. 2. For example, the wireless device may transmit, to the network entity 105 and according to the at least one configuration, the report that indicates one or more of the sensed shape of the target entity 210 or the sensed dimension of the target entity 210. One or more of the shape of the target entity 210 or the dimension of the target entity 210 may be indicated (e.g., reported) according to a shape/object format (e.g., .fbx, .3ds, .obj, .stl, .stp, .dae, .3mf, .usdz, .usd, .gltf, .glb, .iges, .blend). In some other examples, one or more of the shape of the target entity 210 or the dimension of the target entity 210 may be indicated (e.g., reported) according to one or more of bounding box information or bounding sphere information. In other examples, the wireless device may support indexing of one or more of the shape of the target entity 210 or the dimension of the target entity 210.

The at least one configuration for reporting one or more of the shape of a target entity or the dimension of the target entity may include a set of indexes, each index corresponding to a type of target entity, a category associated with the type of target entity, and information (e.g., size, dimension) associated with the target entity. For example, the at least one configuration may indicate different reporting formats for different types of target entities, categories associated with different types of target entities, and different information (e.g., size, dimension) associated with the different types of target entities. By way of example, a first index may correspond to a human as a target entity (e.g., 0—human), a second index may correspond to a vehicle as the target entity (e.g., 1—car), a third index may correspond to a UAV as the target entity (e.g., 2—UAV), a fourth index may correspond to a box as the target entity (e.g., 3—box), a fifth index may correspond to a sphere as the target entity (e.g., 4—sphere), a sixth index may correspond to a table as the target entity (e.g., 5—table), a seventh index may correspond to a chair as the target entity (e.g., 6—chair), etc. The information (e.g., size, dimension) associated with the target entity may be indicated by bounding box information, bounding parallelogram information, bounding sphere information, etc. The operations may be performed in accordance with examples as disclosed herein.

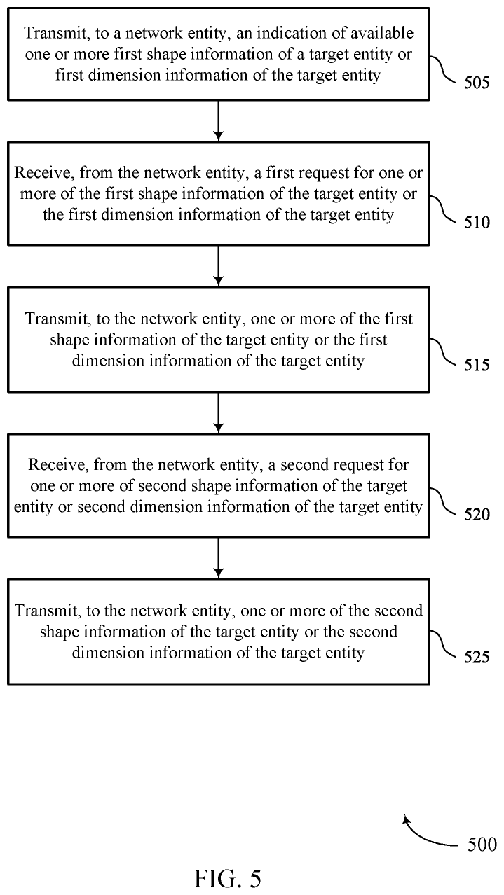

FIG. 5 shows an example of a method 500 that supports sensing and reporting geometric information associated with sensing targets in accordance with one or more aspects of the present disclosure. The operations of the method 500 may be implemented by a wireless device (e.g., a UE or a TRP) or its components as described herein. For example, the operations of the method 500 may be performed by a UE 115 as described with reference to FIGS. 1 and 2. In some examples, a wireless device may execute a set of instructions to control the functional elements of the wireless device to perform the described functions. Additionally, or alternatively, the wireless device may perform aspects of the described functions using special-purpose hardware.

In the example of FIG. 5, to manage resources (e.g., OTA resources) and overhead signaling, the method 500 may support incremental (e.g., step-by-step, iterative) obtaining and reporting of geometric information (e.g., size, dimension) associated with a target entity. For example, the incremental obtaining and reporting of geometric information (e.g., size, dimension) may begin with a low resolution and end with a high resolution, for example, based on a condition (e.g., demand, request).

At 505, the method may include transmitting, to a network entity, an indication of available one or more first shape information of a target entity or first dimension information of the target entity. The network entity may be an example of a network entity 105 as described with reference to FIGS. 1 and 2. The target entity may be an example of a target entity 210 as described with reference to FIG. 2. The operations may be performed in accordance with examples as disclosed herein. The network entity may be an example of a network entity 105 as described with reference to FIGS. 1 and 2.

At 510, the method may include receiving, from the network entity, a first request for one or more of the first shape information of the target entity or the first dimension information of the target entity. The network entity may be an example of a network entity 105 as described with reference to FIGS. 1 and 2. The target entity may be an example of a target entity 210 as described with reference to FIG. 2. For example, the wireless device (e.g., a UE, a TRP) may receive, from a network entity 105 (e.g., an LMF, an SnMF), a first request message for first geometric information (e.g., the first shape information, the first dimension information) associated with the target entity 210. The wireless device may obtain the first geometric information, for example, based on an RF sensing procedure according to a first set of one or more sensing parameters. The operations may be performed in accordance with examples as disclosed herein.

At 515, the method may include transmitting, to the network entity, one or more of the first shape information of the target entity or the first dimension information of the target entity. The network entity may be an example of a network entity 105 as described with reference to FIGS. 1 and 2. The target entity may be an example of a target entity 210 as described with reference to FIG. 2. For example, the wireless device (e.g., the UE, the TRP) may transmit, to the network entity 105 (e.g., the LMF, the SnMF), the first geometric information (e.g., the first shape information, the first dimension information) associated with the target entity 210. The operations may be performed in accordance with examples as disclosed herein.

At 520, the method may include receiving, from the network entity, a second request for one or more of second shape information of the target entity or second dimension information of the target entity. The network entity may be an example of a network entity 105 as described with reference to FIGS. 1 and 2. The target entity may be an example of a target entity 210 as described with reference to FIG. 2. For example, the wireless device (e.g., the UE, the TRP) may receive, from the network entity 105 (e.g., the LMF, the SnMF), the second request message for second geometric information (e.g., the second shape information, the second dimension information) associated with the target entity 210. The wireless device may obtain the second geometric information, for example, based on the RF sensing procedure according to a second set of one or more sensing parameters. In some examples, one or more of the second shape information of the target entity 210 or the second dimension information of the target entity 210 may be associated with a higher resolution (e.g., by a delta) compared to one or more of the first shape information of the target entity 210 or the first dimension information of the target entity 210. Put another way, one or more of the second shape information or the second dimension information of the target entity 210 may have a higher accuracy (e.g., of characteristics and properties of the target entity) compared to one or more of the first shape information or the first dimension information of the target entity 210. The operations may be performed in accordance with examples as disclosed herein. The second shape information or second dimension information may control the delta for the resolution to be added to the first shape information or the first dimension information.

At 525, the method may include transmitting, to the network entity, one or more of the second shape information of the target entity or the second dimension information of the target entity. The network entity may be an example of a network entity 105 as described with reference to FIGS. 1 and 2. The target entity may be an example of a target entity 210 as described with reference to FIG. 2. The operations may be performed in accordance with examples as disclosed herein.

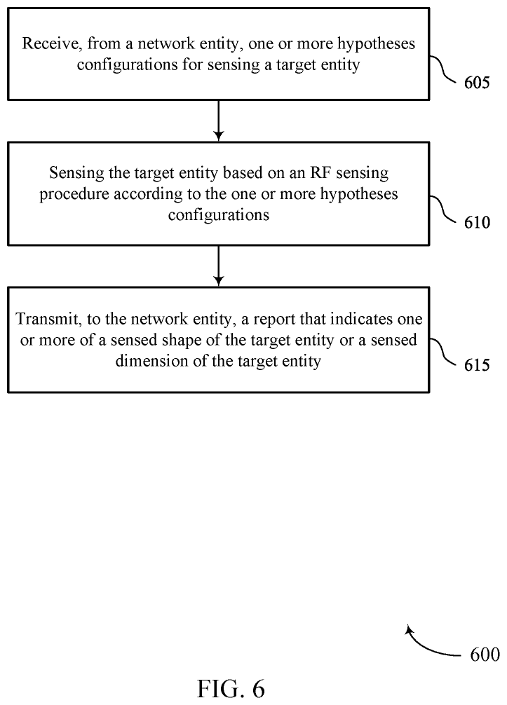

FIG. 6 shows an example of a method 600 that supports sensing and reporting geometric information associated with sensing targets in accordance with one or more aspects of the present disclosure. The operations of the method 600 may be implemented by a wireless device (e.g., a UE or a TRP) or its components as described herein. For example, the operations of the method 600 may be performed by a UE 115 as described with reference to FIGS. 1 and 2. In some examples, a wireless device may execute a set of instructions to control the functional elements of the wireless device to perform the described functions. Additionally, or alternatively, the wireless device may perform aspects of the described functions using special-purpose hardware.

At 605, the method may include receiving, from a network entity, one or more hypotheses configurations for sensing a target entity. The network entity may be an example of a network entity 105 as described with reference to FIGS. 1 and 2. The target entity may be an example of a target entity 210 as described with reference to FIG. 2. For example, the wireless device (e.g., a UE, a TRP) may receive, from the network entity 105 (e.g., an LMF, an SnMF), one or more hypotheses configurations for sensing one or more of a shape of the target entity 210 or a dimension of the target entity 210. Each of the one or more hypotheses configurations may indicate a set of parameters. The set of parameters may indicate one or more of a sensing procedure for sensing the target entity 210 (e.g., methods for sensing one or more of the shape of the target entity 210 or the dimension of the target entity 210), a center frequency associated with sensing the target entity 210 (e.g., one or more center frequencies for sensing one or more of the shape of the target entity 210 or the dimension of the target entity 210), or a bandwidth associated with sensing the target entity 210 (e.g., one or more bandwidths for sensing one or more of the shape of the target entity 210 or the dimension of the target entity 210). The operations may be performed in accordance with examples as disclosed herein.

At 610, the method may include sensing the target entity based on an RF sensing procedure according to the one or more hypotheses configurations. The target entity may be an example of a target entity 210 as described with reference to FIG. 2. For example, the wireless device (e.g., the UE, the TRP) may conduct (e.g., perform) RF sensing based on transmission and reception of one or more reference signals and according to the one or more hypotheses configurations. During the RF sensing, the wireless device may obtain multiple estimates of one or more of the shape of the target entity 210 or the dimension of the target entity 210. The operations may be performed in accordance with examples as disclosed herein.

At 615, the method may include transmitting, to the network entity, a report that indicates one or more of a sensed shape of the target entity or a sensed dimension of the target entity. The network entity may be an example of a network entity 105 as described with reference to FIGS. 1 and 2. The target entity may be an example of a target entity 210 as described with reference to FIG. 2. For example, the wireless device (e.g., the UE, the TRP) may report the obtained multiple estimates of one or more of the shape of the target entity 210 or the dimension of the target entity 210 with a soft-indicator on each of the one or more of the shape of the target entity 210 or the dimension of the target entity 210. The operations may be performed in accordance with examples as disclosed herein.

Put another way, the wireless device (e.g., the UE, the TRP) may receive, from the network entity 105 (e.g., the LMF, the SnMF), a request to provide plurality of target shape and dimension information all corresponding to the target entity 210, to account for uncertainty on the target shape and dimension associated with the target entity 210. In some examples, the target shape and dimension information may be configured by the network entity 105. In some other examples, the target shape and dimension information may be selected autonomously by the wireless device.

The wireless device may conduct RF sensing and report the obtained target shape and dimension information with a quality metric for each shape and dimension information. The target shape and dimension information of the target entity 210 may correspond to RF sensing using different center frequencies, methods for detecting and estimating target shape and dimension information, bandwidths for the RF sensing. The quality metric (also referred to as quality score) may include (e.g., indicate) a probability of a likelihood of each shape and dimension information being associated with an actual shape and dimension of the target entity 210. Additionally, or alternatively, the quality metric may include (e.g., indicate) a confidence interval.

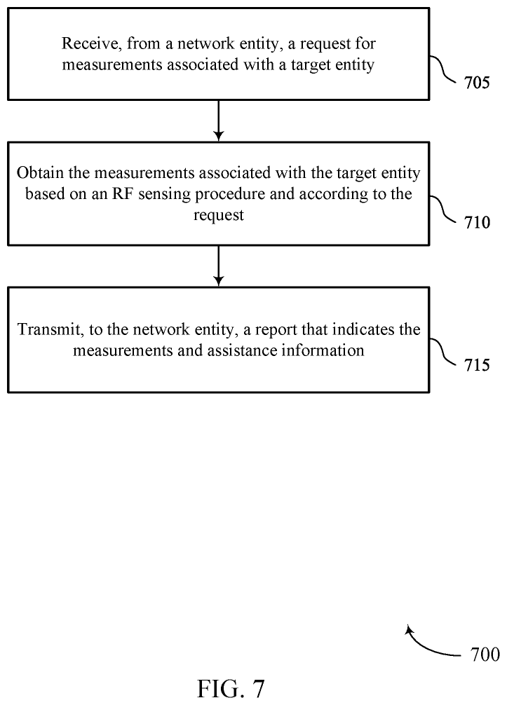

FIG. 7 shows an example of a method 700 that supports sensing and reporting geometric information associated with sensing targets in accordance with one or more aspects of the present disclosure. The operations of the method 700 may be implemented by a wireless device (e.g., a UE or a TRP) or its components as described herein. For example, the operations of the method 700 may be performed by a UE 115 as described with reference to FIGS. 1 and 2. In some examples, a wireless device may execute a set of instructions to control the functional elements of the wireless device to perform the described functions. Additionally, or alternatively, the wireless device may perform aspects of the described functions using special-purpose hardware.

At 705, the method may include receiving, from a network entity, a request for measurements associated with a target entity. The network entity may be an example of a network entity 105 as described with reference to FIGS. 1 and 2. The target entity may be an example of a target entity 210 as described with reference to FIG. 2. For example, the wireless device (e.g., a UE, a TRP) may receive, from a network entity 105 (e.g., an LMF, an SnMF), a request for one or more measurement values associated with sensing of the target entity 210. In some examples, the network entity 105 (e.g., an LMF, an SnMF) may determine, based on the provided one or more measurement values, geometric information (e.g., shape, dimension) associated with the target entity 210. The operations may be performed in accordance with examples as disclosed herein.

At 710, the method may include obtaining the measurements associated with the target entity based on an RF sensing procedure and according to the request. The target entity may be an example of a target entity 210 as described with reference to FIG. 2. For example, the wireless device may perform the RF sensing procedure and obtain one or more measurement values associated with the target entity 210. The operations may be performed in accordance with examples as disclosed herein.

At 715, the method may include transmitting, to the network entity, a report that indicates the measurements and assistance information. The network entity may be an example of a network entity 105 as described with reference to FIGS. 1 and 2. The target entity may be an example of a target entity 210 as described with reference to FIG. 2. For example, the wireless device may transmit, to the network entity 105, a report that indicates the one or more measurement values and assistance information. Put another way, the wireless device may provide assistance information to help the network entity 105 in determining one or more of a shape or a dimension associated with the target entity 210. In some examples, the one or more measurement values may correspond to raw sensing measurement values. The wireless device may provide coarse estimates of one or more of the shape or dimension associated with the target entity 210. Examples of assistance information (also referred to assistance data) may include one or more of an expected shape associated with the target entity 210 or an expected dimension associated with the target entity 210. The assistance information may be indicated according to a shape/object format (e.g., .fbx, .3ds, .obj, .stl, stp, .dae, .3MF, .usdz, .usd, .gltf, .glb, .iges, .blend, and the like). Additionally, or alternatively, the assistance information may include one or more of bounding box information or bounding sphere information indicative of one or more of the expected shape associated with the target entity 210 or the expected dimension associated with the target entity 210. The operations may be performed in accordance with examples as disclosed herein.

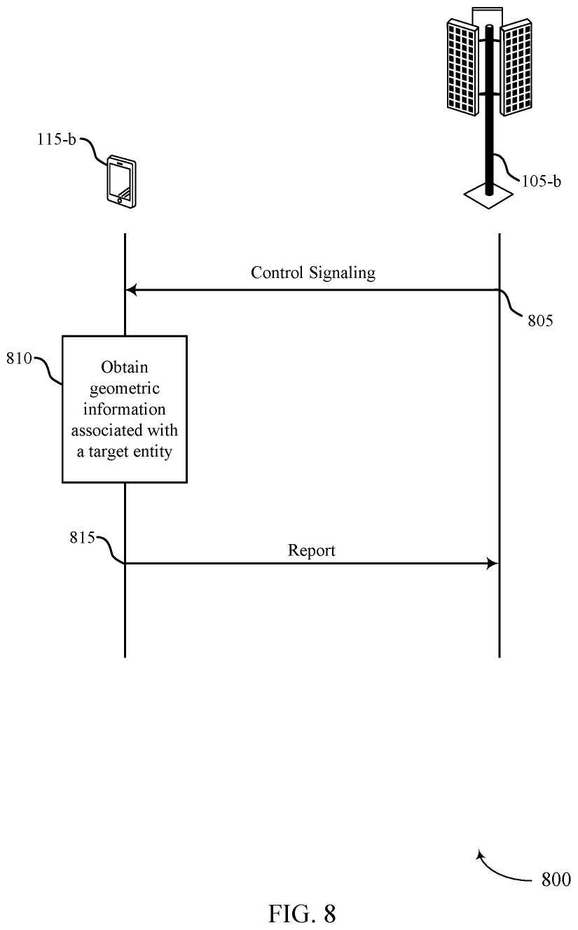

FIG. 8 shows an example of a process flow 800 that supports sensing and reporting geometric information associated with sensing targets in accordance with one or more aspects of the present disclosure. The process flow 800 may implement aspects of the wireless communications system 100 and the wireless communications system 200 as described with reference to FIGS. 1 and 2, respectively. The process flow 800 may include a network entity 105-b and a UE 115-b, which may be examples of a network entity and a UE as described herein. In the example of FIG. 8, the network entity 105-b may an LMF or an SnMF, while the UE 115-b may be a UE or a TRP, or other examples of UEs as described herein.

In the following description of the process flow 800, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 800, and other operations may be added to the process flow 800.

At 805, the network entity 105-b may transmit, to the UE 115-b, control signaling including a configuration for sensing and reporting information of a target entity. The UE 115-b may receive, from the network entity 105-b, the control signaling including the configuration for sensing and reporting information of the target entity. The control signaling may include a SIB, which may be a posSIB or a senseSIB. In some examples, the UE 115-b may transmit, to the network entity 105-b, capability information associated with the UE 115-b for sensing the target entity, wherein receiving the control signaling including the configuration is based on the capability information.

At 810, the UE 115-b may obtain geometric information associated with the target entity based on an RF sensing procedure according to the configuration. The UE 115-b may identify expected geometric information associated with the target entity based on the configuration. The expected geometric information may include one or more of an expected shape associated with the target entity or an expected dimension associated with the target entity. The UE 115-b may perform the RF sensing procedure based on the expected geometric information associated with the target entity. In some examples, the expected geometric information may correspond to at least one format of indicating one or more of the expected shape associated with the target entity or the expected dimension associated with the target entity. Additionally, or alternatively, the expected geometric information may include one or more of bounding box information or bounding sphere information indicative of one or more of the expected shape associated with the target entity or the expected dimension associated with the target entity. In some other examples, the UE 115-b may identify resolution information for sensing the target entity based on the configuration. The resolution information may include a preferred beam-range resolution indicating one or more of a preferred beam range or a preferred beam azimuth. The UE 115-b may perform the RF sensing procedure based on the resolution information.

At 815, the UE 115-b may transmit, to the network entity 105-b, a report including the geometric information associated with the target entity. In some examples, the UE 115-b may identify at least one report format of the report including the geometric information associated with the target entity based on the configuration.

FIG. 9 shows a block diagram 900 of a device 905 that supports sensing and reporting geometric information associated with sensing targets in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to sensing and reporting geometric information associated with sensing targets). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sensing and reporting geometric information associated with sensing targets). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of sensing and reporting geometric information associated with sensing targets as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code such as processor-executable code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a network entity, control signaling including a configuration for sensing and reporting information of a target entity in a wireless communication system. The communications manager 920 is capable of, configured to, or operable to support a means for obtaining geometric information associated with the target entity in the wireless communication system based on an RF sensing procedure according to the configuration. The communications manager 920 is capable of, configured to, or operable to support a means for transmitting, to the network entity, a report including the geometric information associated with the target entity.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing.

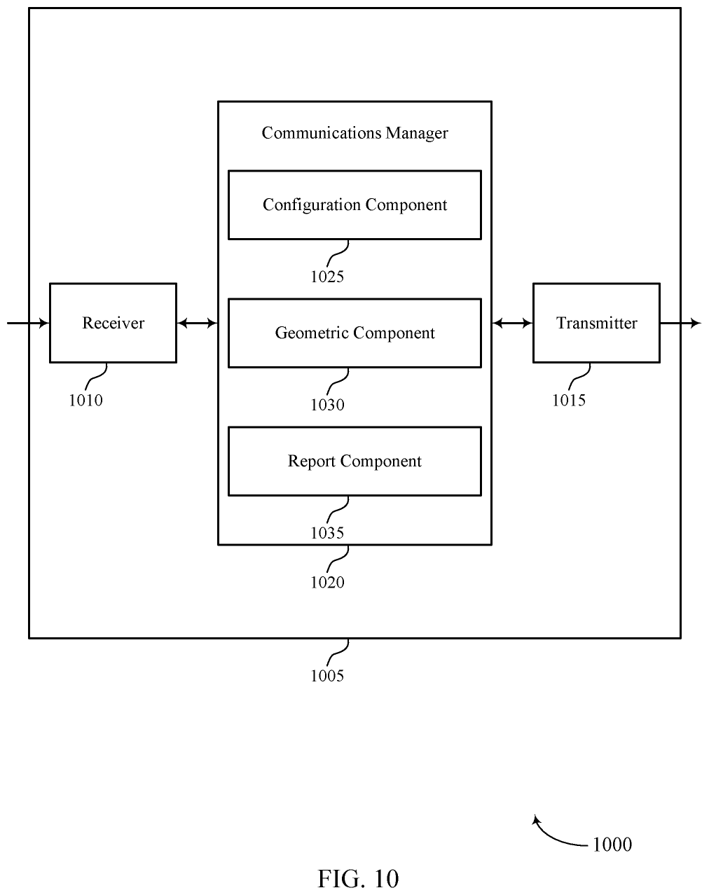

FIG. 10 shows a block diagram 1000 of a device 1005 that supports sensing and reporting geometric information associated with sensing targets in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to sensing and reporting geometric information associated with sensing targets). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to sensing and reporting geometric information associated with sensing targets). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of sensing and reporting geometric information associated with sensing targets as described herein. For example, the communications manager 1020 may include a configuration component 1025, a geometric component 1030, a report component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration component 1025 is capable of, configured to, or operable to support a means for receiving, from a network entity, control signaling including a configuration for sensing and reporting information of a target entity in a wireless communication system. The geometric component 1030 is capable of, configured to, or operable to support a means for obtaining geometric information associated with the target entity in the wireless communication system based on an RF sensing procedure according to the configuration. The report component 1035 is capable of, configured to, or operable to support a means for transmitting, to the network entity, a report including the geometric information associated with the target entity.

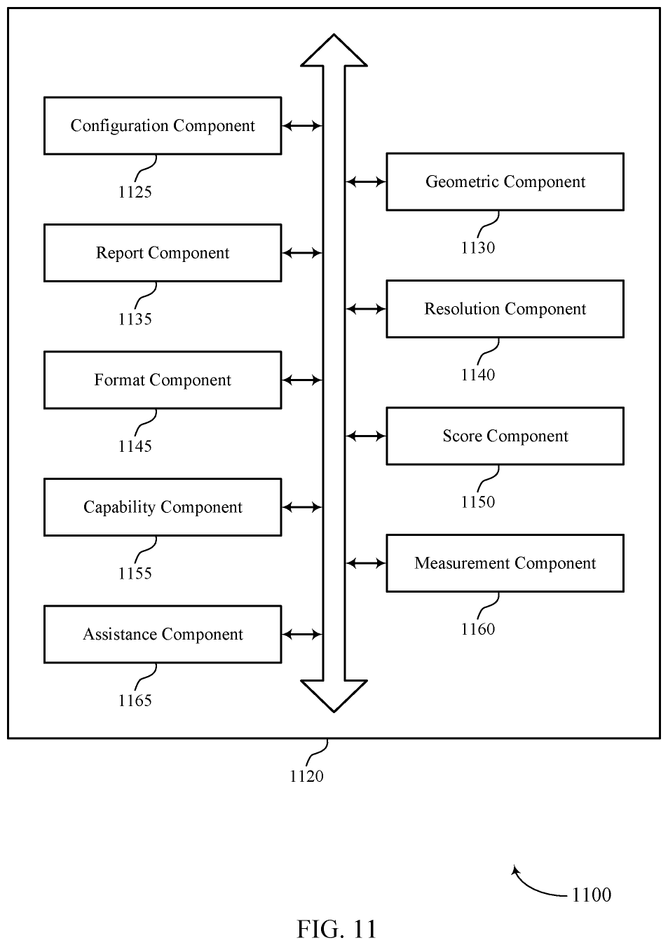

FIG. 11 shows a block diagram 1100 of a communications manager 1120 that supports sensing and reporting geometric information associated with sensing targets in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of sensing and reporting geometric information associated with sensing targets as described herein. For example, the communications manager 1120 may include a configuration component 1125, a geometric component 1130, a report component 1135, a resolution component 1140, a format component 1145, a score component 1150, a capability component 1155, a measurement component 1160, an assistance component 1165, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The configuration component 1125 is capable of, configured to, or operable to support a means for receiving, from a network entity, control signaling including a configuration for sensing and reporting information of a target entity in a wireless communication system. The geometric component 1130 is capable of, configured to, or operable to support a means for obtaining geometric information associated with the target entity in the wireless communication system based on an RF sensing procedure according to the configuration. The report component 1135 is capable of, configured to, or operable to support a means for transmitting, to the network entity, a report including the geometric information associated with the target entity.

In some examples, the geometric component 1130 is capable of, configured to, or operable to support a means for identifying expected geometric information associated with the target entity based on the configuration, the expected geometric information including one or more of an expected shape associated with the target entity or an expected dimension associated with the target entity, and where the RF sensing procedure is based on the expected geometric information associated with the target entity.

In some examples, the expected geometric information corresponds to at least one format of indicating one or more of the expected shape associated with the target entity or the expected dimension associated with the target entity. In some examples, the expected geometric information includes one or more of bounding box information or bounding sphere information indicative of one or more of the expected shape associated with the target entity or the expected dimension associated with the target entity.

In some examples, the resolution component 1140 is capable of, configured to, or operable to support a means for identifying resolution information for sensing the target entity based on the configuration, where the resolution information includes a preferred beam-range resolution indicating one or more of a preferred beam range or a preferred beam azimuth, and where the RF sensing procedure is based on the resolution information for sensing the target entity.

In some examples, the format component 1145 is capable of, configured to, or operable to support a means for identifying at least one report format of the report including the geometric information associated with the target entity based on the configuration, the report including the geometric information associated with the target entity is based on the at least one report format.

In some examples, the geometric component 1130 is capable of, configured to, or operable to support a means for receiving, from the network entity, a first request message for first geometric information associated with the target entity. In some examples, the geometric component 1130 is capable of, configured to, or operable to support a means for obtaining the first geometric information associated with the target entity based on the RF sensing procedure and a first set of parameters associated with the configuration. In some examples, the geometric component 1130 is capable of, configured to, or operable to support a means for transmitting, to the network entity, a first response message including the first geometric information associated with the target entity based on the first request message for the first geometric information associated with the target entity.

In some examples, the geometric component 1130 is capable of, configured to, or operable to support a means for receiving, from the network entity, a second request message for second geometric information associated with the target entity based on the first response message including the first geometric information associated with the target entity. In some examples, the geometric component 1130 is capable of, configured to, or operable to support a means for obtaining the second geometric information associated with the target entity based on the RF sensing procedure and a second set of parameters associated with the configuration, where the second set of parameters is different than the first set of parameters. In some examples, the geometric component 1130 is capable of, configured to, or operable to support a means for transmitting, to the network entity, a second response message including the second geometric information associated with the target entity based on the second request message for the second geometric information associated with the target entity.

In some examples, the geometric information includes one or more of the first geometric information associated with the target entity or the second geometric information associated with the target entity.

In some examples, the configuration component 1125 is capable of, configured to, or operable to support a means for receiving, from the network entity, the control signaling including a set of multiple hypotheses configurations for sensing the target entity, where each hypothesis configuration of the set of multiple hypotheses configurations for sensing the target entity includes a set of parameters, and where the set of parameters indicates one or more of a sensing procedure for sensing the target entity, a center frequency associated with sensing the target entity, or a bandwidth associated with sensing the target entity. In some examples, the geometric component 1130 is capable of, configured to, or operable to support a means for obtaining geometric information associated with the target entity based on the set of multiple hypotheses configurations for sensing the target entity. In some examples, the score component 1150 is capable of, configured to, or operable to support a means for assigning a corresponding quality score for each of the geometric information. In some examples, the report component 1135 is capable of, configured to, or operable to support a means for transmitting, to the network entity, the report including the geometric information associated with the target entity and the assigned quality score for each of the geometric information.

In some examples, the corresponding quality score indicates a probability of each of the geometric information associated with the target entity or a confidence of each of the geometric information associated with the target entity.

In some examples, the capability component 1155 is capable of, configured to, or operable to support a means for transmitting, to the network entity, capability information associated with the wireless device for sensing the target entity, where receiving, from the network entity, the control signaling including the configuration is based on transmitting, to the network entity, the capability information associated with the wireless device for sensing the target entity.

In some examples, the capability component 1155 is capable of, configured to, or operable to support a means for receiving, from the network entity, a request message for the capability information associated with the wireless device for sensing the target entity, where transmitting, to the network entity, the capability information is based on receiving, from the network entity, the request message for the capability information associated with the wireless device for sensing the target entity.

In some examples, the measurement component 1160 is capable of, configured to, or operable to support a means for obtaining one or more measurement values associated with the target entity based on the RF sensing procedure. In some examples, the assistance component 1165 is capable of, configured to, or operable to support a means for determining assistance information based on the one or more measurement values associated with the target entity, where the assistance information includes one or more of an expected shape associated with the target entity or an expected dimension associated with the target entity. In some examples, the report component 1135 is capable of, configured to, or operable to support a means for transmitting, to the network entity, an indication of at least one of the one or more measurement values or the assistance information associated with the target entity.

In some examples, the wireless device includes a UE or a TRP.

In some examples, the network entity includes a network entity including one or more of a LMF or a SnMF.

In some examples, the control signaling includes an SIB. In some examples, the SIB includes a posSIB or a senseSIB.

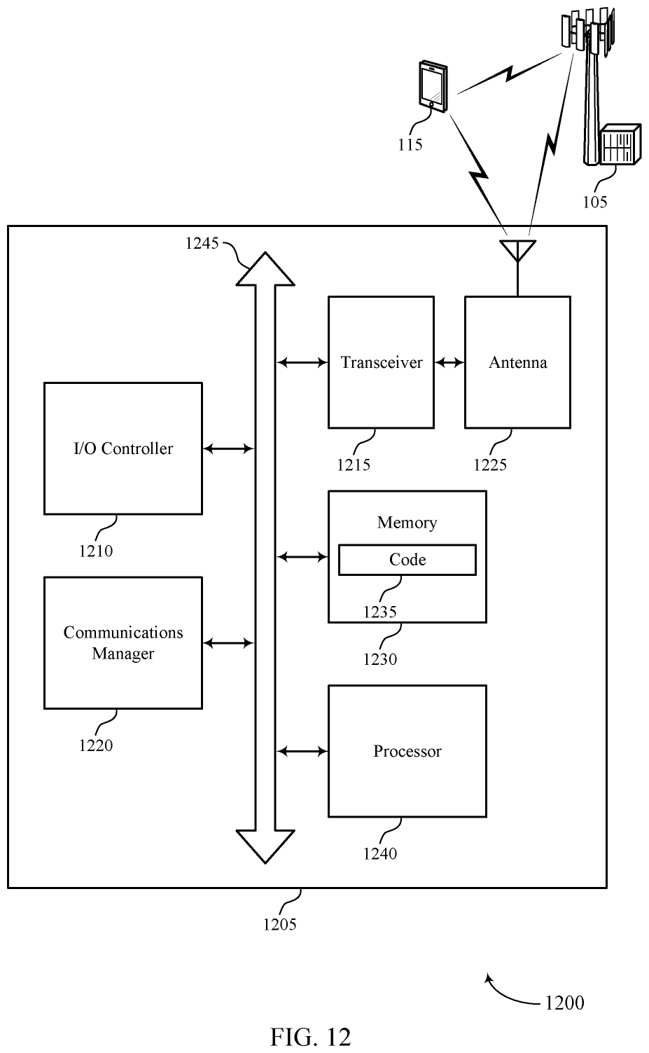

FIG. 12 shows a diagram of a system 1200 including a device 1205 that supports sensing and reporting geometric information associated with sensing targets in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting sensing and reporting geometric information associated with sensing targets). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving, from a network entity, control signaling including a configuration for sensing and reporting information of a target entity in a wireless communication system. The communications manager 1220 is capable of, configured to, or operable to support a means for obtaining geometric information associated with the target entity in the wireless communication system based on an RF sensing procedure according to the configuration. The communications manager 1220 is capable of, configured to, or operable to support a means for transmitting, to the network entity, a report including the geometric information associated with the target entity.

By including or configuring the communications manager 1220 in accordance with examples as described herein, the device 1205 may support techniques for improved user experience related to reduced processing and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of sensing and reporting geometric information associated with sensing targets as described herein, or the at least one processor 1240 and the at least one memory 1230 may be otherwise configured to, individually or collectively, perform or support such operations.

FIG. 13 shows a block diagram 1300 of a device 1305 that supports sensing and reporting geometric information associated with sensing targets in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of sensing and reporting geometric information associated with sensing targets as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting, to a wireless device, control signaling including a configuration for sensing and reporting information of a target entity in a wireless communication system. The communications manager 1320 is capable of, configured to, or operable to support a means for receiving, from the wireless device, a report including geometric information associated with the target entity based on the configuration for sensing and reporting information of the target entity.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing.

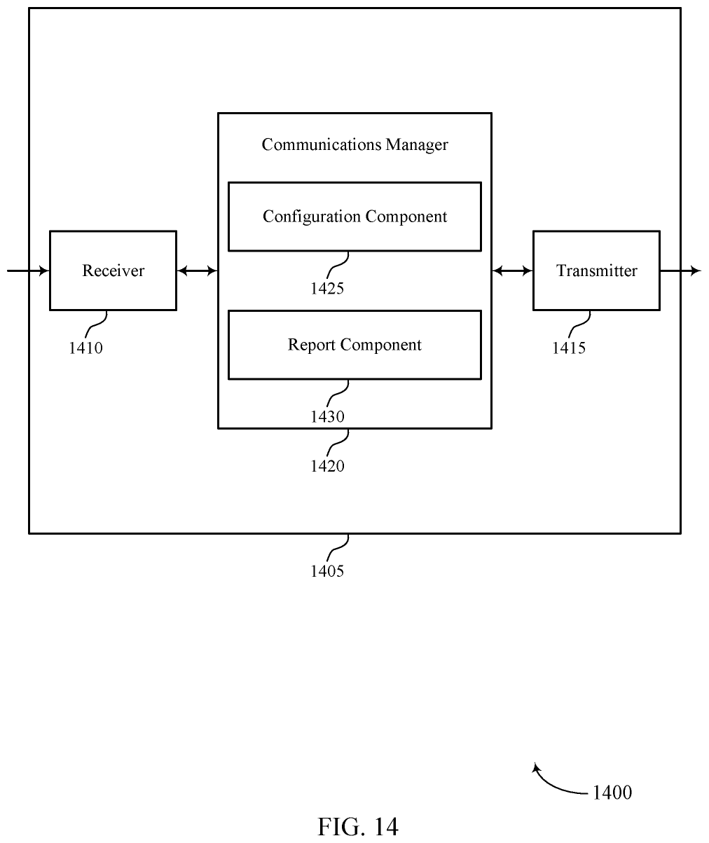

FIG. 14 shows a block diagram 1400 of a device 1405 that supports sensing and reporting geometric information associated with sensing targets in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one of more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of sensing and reporting geometric information associated with sensing targets as described herein. For example, the communications manager 1420 may include a configuration component 1425 a report component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The configuration component 1425 is capable of, configured to, or operable to support a means for transmitting, to a wireless device, control signaling including a configuration for sensing and reporting information of a target entity in a wireless communication system. The report component 1430 is capable of, configured to, or operable to support a means for receiving, from the wireless device, a report including geometric information associated with the target entity based on the configuration for sensing and reporting information of the target entity.

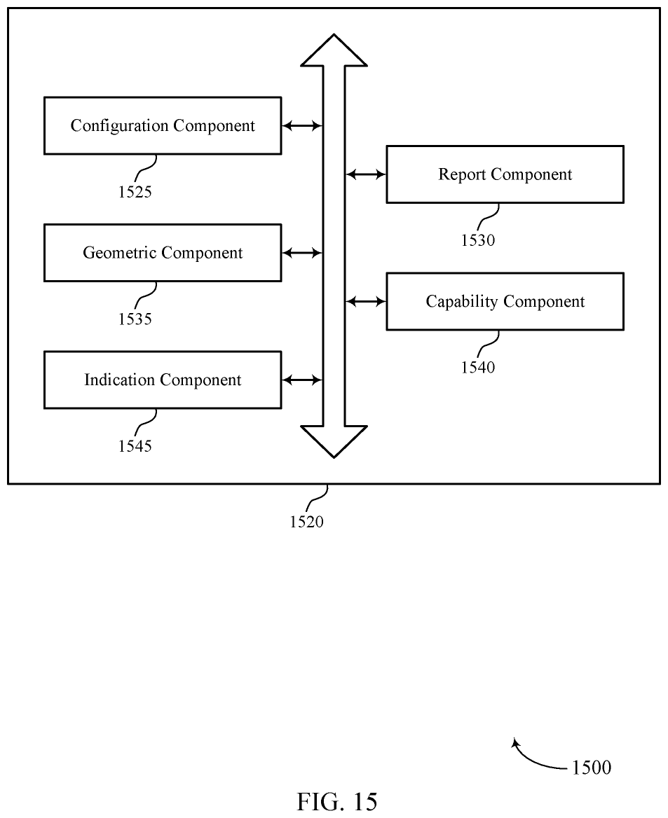

FIG. 15 shows a block diagram 1500 of a communications manager 1520 that supports sensing and reporting geometric information associated with sensing targets in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of sensing and reporting geometric information associated with sensing targets as described herein. For example, the communications manager 1520 may include a configuration component 1525, a report component 1530, a geometric component 1535, a capability component 1540, an indication component 1545, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The configuration component 1525 is capable of, configured to, or operable to support a means for transmitting, to a wireless device, control signaling including a configuration for sensing and reporting information of a target entity in a wireless communication system. The report component 1530 is capable of, configured to, or operable to support a means for receiving, from the wireless device, a report including geometric information associated with the target entity based on the configuration for sensing and reporting information of the target entity.

In some examples, the configuration identifies expected geometric information associated with the target entity. In some examples, the expected geometric information includes one or more of an expected shape associated with the target entity or an expected dimension associated with the target entity.

In some examples, the expected geometric information corresponds to at least one format of indicating one or more of the expected shape associated with the target entity or the expected dimension associated with the target entity. In some examples, the expected geometric information includes one or more of bounding box information or bounding sphere information indicative of one or more of the expected shape associated with the target entity or the expected dimension associated with the target entity.

In some examples, the configuration identifies resolution information for sensing the target entity. In some examples, the resolution information includes a preferred beam-range resolution indicating one or more of a preferred beam range or a preferred beam azimuth.

In some examples, the configuration identifies at least one report format of the report including the geometric information associated with the target entity based on the configuration.

In some examples, the geometric component 1535 is capable of, configured to, or operable to support a means for transmitting, to the wireless device, a first request message for first geometric information associated with the target entity. In some examples, the geometric component 1535 is capable of, configured to, or operable to support a means for receiving, from the wireless device, a first response message including the first geometric information associated with the target entity based on the first request message for the first geometric information associated with the target entity.

In some examples, the geometric component 1535 is capable of, configured to, or operable to support a means for transmitting, to the wireless device, a second request message for second geometric information associated with the target entity based on the first response message including the first geometric information associated with the target entity. In some examples, the geometric component 1535 is capable of, configured to, or operable to support a means for receiving, from the wireless device, a second response message including the second geometric information associated with the target entity based on the second request message for the second geometric information associated with the target entity.

In some examples, the geometric information includes one or more of the first geometric information associated with the target entity or the second geometric information associated with the target entity.

In some examples, the configuration component 1525 is capable of, configured to, or operable to support a means for transmitting, to the wireless device, the control signaling including a set of multiple hypotheses configurations for sensing the target entity, where each hypothesis configuration of the set of multiple hypotheses configurations for sensing the target entity includes a set of parameters, and where the set of parameters indicates one or more of a sensing procedure for sensing the target entity, a center frequency associated with sensing the target entity, or a bandwidth associated with sensing the target entity. In some examples, the report component 1530 is capable of, configured to, or operable to support a means for receiving, from the wireless device, the report including a set of multiple geometric information associated with the target entity and assigned corresponding quality score for each corresponding geometric information of the set of multiple geometric information.

In some examples, the assigned corresponding quality score indicates a probability of each geometric information of the set of multiple geometric information associated with the target entity or a confidence of each geometric information of the set of multiple geometric information associated with the target entity.

In some examples, the capability component 1540 is capable of, configured to, or operable to support a means for receiving, from the wireless device, capability information associated with the wireless device for sensing the target entity. In some examples, the configuration component 1525 is capable of, configured to, or operable to support a means for where transmitting, to the wireless device, the control signaling including the configuration is based on receiving, from the wireless device, the capability information associated with the wireless device for sensing the target entity.

In some examples, the capability component 1540 is capable of, configured to, or operable to support a means for transmitting, to the wireless device, a request message for the capability information associated with the wireless device for sensing the target entity. In some examples, the capability component 1540 is capable of, configured to, or operable to support a means for where receiving, from the wireless device, the capability information is based on transmitting, to the wireless device, the request message for the capability information associated with the wireless device for sensing the target entity.

In some examples, the indication component 1545 is capable of, configured to, or operable to support a means for receiving, from the wireless device, an indication of one or more of one or more measurement values or assistance information associated with the target entity.

In some examples, the wireless device includes a UE or a TRP.

In some examples, the network entity includes a network entity including one or more of a LMF or a SnMF.

In some examples, the control signaling includes an SIB. In some examples, the SIB includes a posSIB or a senseSIB.

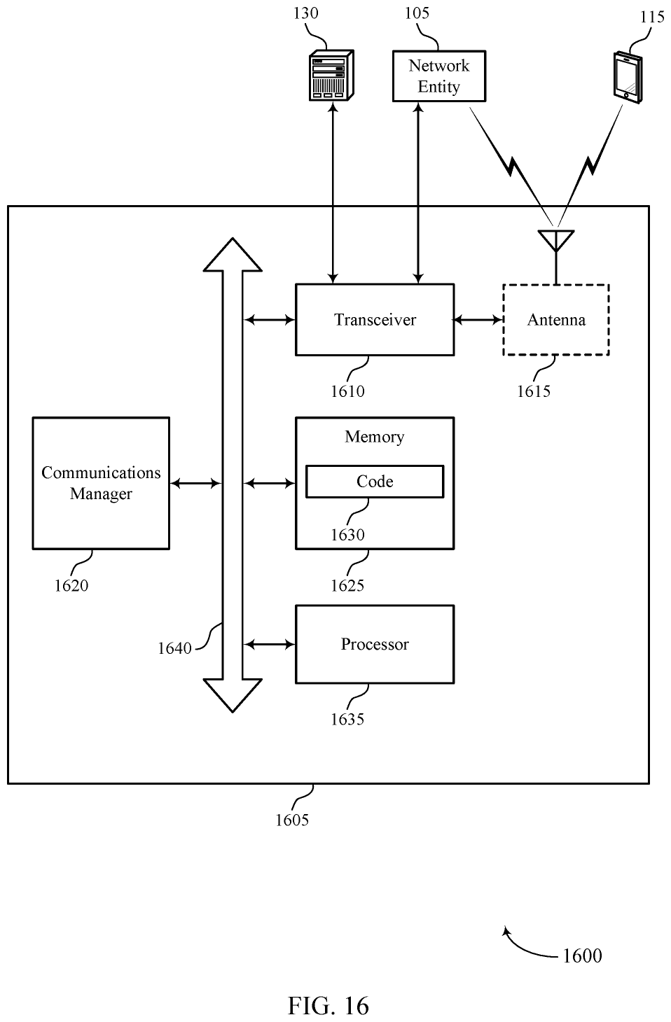

FIG. 16 shows a diagram of a system 1600 including a device 1605 that supports sensing and reporting geometric information associated with sensing targets in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting sensing and reporting geometric information associated with sensing targets). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein.

The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105 (e.g., one or more other network devices), and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting, to a wireless device, control signaling including a configuration for sensing and reporting information of a target entity in a wireless communication system. The communications manager 1620 is capable of, configured to, or operable to support a means for receiving, from the wireless device, a report including geometric information associated with the target entity based on the configuration for sensing and reporting information of the target entity.

By including or configuring the communications manager 1620 in accordance with examples as described herein, the device 1605 may support techniques for improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of sensing and reporting geometric information associated with sensing targets as described herein, or the at least one processor 1635 and the at least one memory 1625 may be otherwise configured to, individually or collectively, perform or support such operations.

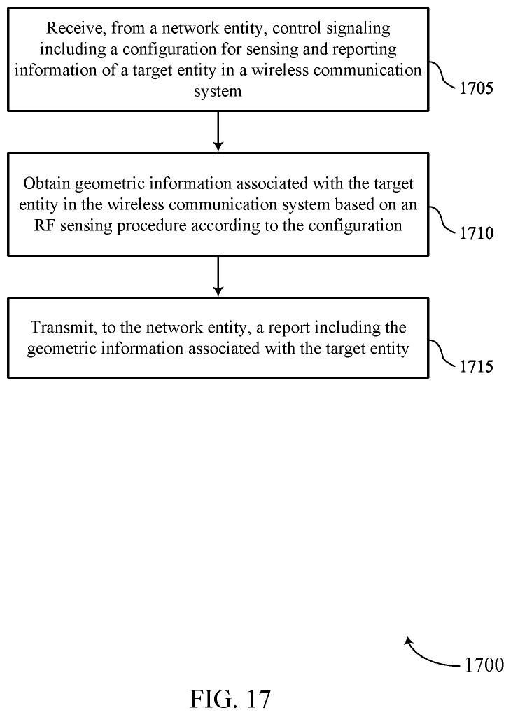

FIG. 17 shows a flowchart illustrating a method 1700 that supports sensing and reporting geometric information associated with sensing targets in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, control signaling including a configuration for sensing and reporting information of a target entity in a wireless communication system. The operations of 1705 may be performed in accordance with examples as disclosed herein. In some examples, aspects of the operations of 1705 may be performed by a configuration component 1125 as described with reference to FIG. 11.

At 1710, the method may include obtaining geometric information associated with the target entity in the wireless communication system based on an RF sensing procedure according to the configuration. The operations of 1710 may be performed in accordance with examples as disclosed herein. In some examples, aspects of the operations of 1710 may be performed by a geometric component 1130 as described with reference to FIG. 11.

At 1715, the method may include transmitting, to the network entity, a report including the geometric information associated with the target entity. The operations of 1715 may be performed in accordance with examples as disclosed herein. In some examples, aspects of the operations of 1715 may be performed by a report component 1135 as described with reference to FIG. 11.

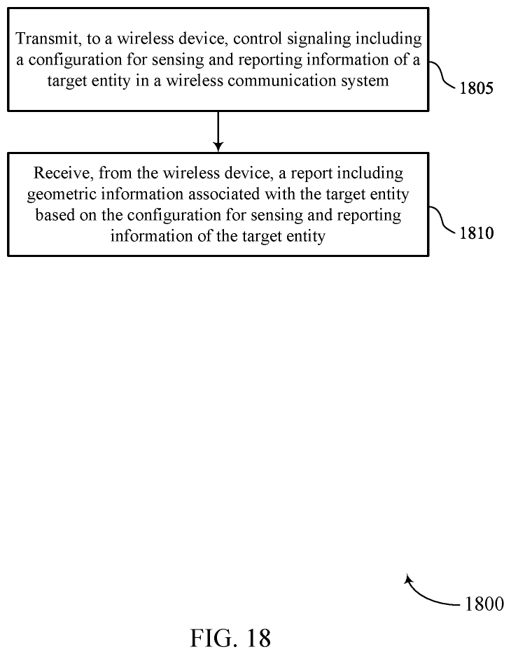

FIG. 18 shows a flowchart illustrating a method 1800 that supports sensing and reporting geometric information associated with sensing targets in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a wireless device, control signaling including a configuration for sensing and reporting information of a target entity in a wireless communication system. The operations of 1805 may be performed in accordance with examples as disclosed herein. In some examples, aspects of the operations of 1805 may be performed by a configuration component 1525 as described with reference to FIG. 15.

At 1810, the method may include receiving, from the wireless device, a report including geometric information associated with the target entity based on the configuration for sensing and reporting information of the target entity. The operations of 1810 may be performed in accordance with examples as disclosed herein. In some examples, aspects of the operations of 1810 may be performed by a report component 1530 as described with reference to FIG. 15.

It should be noted that the methods described herein describe possible implementations. The operations and the steps may be rearranged or otherwise modified and other implementations are possible. Further, aspects from two or more of the methods may be combined.

The following provides an overview of aspects of the present disclosure:

Aspect 1: A method for wireless communications at a wireless device, comprising: receiving, from a network entity, control signaling comprising a configuration for sensing and reporting information of a target entity in a wireless communication system; obtaining geometric information associated with the target entity in the wireless communication system based at least in part on an RF sensing procedure according to the configuration; and transmitting, to the network entity, a report including the geometric information associated with the target entity.

Aspect 2: The method of aspect 1, further comprising: identifying expected geometric information associated with the target entity based at least in part on the configuration, the expected geometric information comprising one or more of an expected shape associated with the target entity or an expected dimension associated with the target entity, and wherein the RF sensing procedure is based at least in part on the expected geometric information associated with the target entity.

Aspect 3: The method of aspect 2, wherein the expected geometric information corresponds to at least one format of indicating one or more of the expected shape associated with the target entity or the expected dimension associated with the target entity; and the expected geometric information comprises one or more of bounding box information or bounding sphere information indicative of one or more of the expected shape associated with the target entity or the expected dimension associated with the target entity.

Aspect 4: The method of any of aspects 1 through 3, further comprising: identifying resolution information for sensing the target entity based at least in part on the configuration, wherein the resolution information comprises a preferred beam-range resolution indicating one or more of a preferred beam range or a preferred beam azimuth, and wherein the RF sensing procedure is based at least in part on the resolution information for sensing the target entity.

Aspect 5: The method of any of aspects 1 through 4, further comprising: identifying at least one report format of the report including the geometric information associated with the target entity based at least in part on the configuration, the report including the geometric information associated with the target entity is based at least in part on the at least one report format.

Aspect 6: The method of any of aspects 1 through 5, further comprising: receiving, from the network entity, a first request message for first geometric information associated with the target entity; obtaining the first geometric information associated with the target entity based at least in part on the RF sensing procedure and a first set of parameters associated with the configuration; and transmitting, to the network entity, a first response message comprising the first geometric information associated with the target entity based at least in part on the first request message for the first geometric information associated with the target entity.

Aspect 7: The method of aspect 6, further comprising: receiving, from the network entity, a second request message for second geometric information associated with the target entity based at least in part on the first response message comprising the first geometric information associated with the target entity; obtaining the second geometric information associated with the target entity based at least in part on the RF sensing procedure and a second set of parameters associated with the configuration, wherein the second set of parameters is different than the first set of parameters; and transmitting, to the network entity, a second response message comprising the second geometric information associated with the target entity based at least in part on the second request message for the second geometric information associated with the target entity.

Aspect 8: The method of aspect 7, wherein the geometric information comprises one or more of the first geometric information associated with the target entity or the second geometric information associated with the target entity.

Aspect 9: The method of any of aspects 1 through 8, further comprising: receiving, from the network entity, the control signaling comprising a plurality of hypotheses configurations for sensing the target entity, wherein each hypothesis configuration of the plurality of hypotheses configurations for sensing the target entity comprises a set of parameters, and wherein the set of parameters indicates one or more of a sensing procedure for sensing the target entity, a center frequency associated with sensing the target entity, or a bandwidth associated with sensing the target entity; obtaining geometric information associated with the target entity based at least in part on the plurality of hypotheses configurations for sensing the target entity; assigning a corresponding quality score for each of the geometric information; and transmitting, to the network entity, the report comprising the geometric information associated with the target entity and the assigned corresponding quality score for each of the geometric information.

Aspect 10: The method of aspect 9, wherein the corresponding quality score indicates a probability of each of the geometric information associated with the target entity or a confidence of each of the geometric information associated with the target entity.

Aspect 11: The method of any of aspects 1 through 10, further comprising: transmitting, to the network entity, capability information associated with the wireless device for sensing the target entity, wherein receiving, from the network entity, the control signaling comprising the configuration is based at least in part on transmitting, to the network entity, the capability information associated with the wireless device for sensing the target entity.

Aspect 12: The method of aspect 11, further comprising: receiving, from the network entity, a request message for the capability information associated with the wireless device for sensing the target entity, wherein transmitting, to the network entity, the capability information is based at least in part on receiving, from the network entity, the request message for the capability information associated with the wireless device for sensing the target entity.

Aspect 13: The method of any of aspects 1 through 12, further comprising: obtaining one or more measurement values associated with the target entity based at least in part on the RF sensing procedure; determining assistance information based at least in part on the one or more measurement values associated with the target entity, wherein the assistance information comprises one or more of an expected shape associated with the target entity or an expected dimension associated with the target entity; and transmitting, to the network entity, an indication of at least one of the one or more measurement values or the assistance information associated with the target entity.

Aspect 14: The method of any of aspects 1 through 13, wherein the wireless device comprises a UE or a TRP.

Aspect 15: The method of any of aspects 1 through 14, wherein the network entity comprises a network entity comprising one or more of an LMF or an SnMF.

Aspect 16: The method of any of aspects 1 through 15, wherein the control signaling comprises an SIB, and the SIB comprises a posSIB or a senseSIB.

Aspect 17: A method for wireless communications at a network entity, comprising: transmitting, to a wireless device, control signaling comprising a configuration for sensing and reporting information of a target entity in a wireless communication system; and receiving, from the wireless device, a report including geometric information associated with the target entity based at least in part on the configuration for sensing and reporting information of the target entity.

Aspect 18: The method of aspect 17, wherein the configuration identifies expected geometric information associated with the target entity, and the expected geometric information comprises one or more of an expected shape associated with the target entity or an expected dimension associated with the target entity.

Aspect 19: The method of aspect 18, wherein the expected geometric information corresponds to at least one format of indicating one or more of the expected shape associated with the target entity or the expected dimension associated with the target entity, and the expected geometric information comprises one or more of bounding box information or bounding sphere information indicative of one or more of the expected shape associated with the target entity or the expected dimension associated with the target entity.

Aspect 20: The method of any of aspects 17 through 19, wherein the configuration identifies resolution information for sensing the target entity, and the resolution information comprises a preferred beam-range resolution indicating one or more of a preferred beam range or a preferred beam azimuth.

Aspect 21: The method of any of aspects 17 through 20, wherein the configuration identifies at least one report format of the report including the geometric information associated with the target entity based at least in part on the configuration.

Aspect 22: The method of any of aspects 17 through 21, further comprising: transmitting, to the wireless device, a first request message for first geometric information associated with the target entity; and receiving, from the wireless device, a first response message comprising the first geometric information associated with the target entity based at least in part on the first request message for the first geometric information associated with the target entity.

Aspect 23: The method of aspect 22, further comprising: transmitting, to the wireless device, a second request message for second geometric information associated with the target entity based at least in part on the first response message comprising the first geometric information associated with the target entity; and receiving, from the wireless device, a second response message comprising the second geometric information associated with the target entity based at least in part on the second request message for the second geometric information associated with the target entity.

Aspect 24: The method of aspect 23, wherein the geometric information comprises one or more of the first geometric information associated with the target entity or the second geometric information associated with the target entity.

Aspect 25: The method of any of aspects 17 through 24, further comprising: transmitting, to the wireless device, the control signaling comprising a plurality of hypotheses configurations for sensing the target entity, wherein each hypothesis configuration of the plurality of hypotheses configurations for sensing the target entity comprises a set of parameters, and wherein the set of parameters indicates one or more of a sensing procedure for sensing the target entity, a center frequency associated with sensing the target entity, or a bandwidth associated with sensing the target entity; and receiving, from the wireless device, the report comprising a plurality of geometric information associated with the target entity and assigned corresponding quality score for each corresponding geometric information of the plurality of geometric information.

Aspect 26: The method of aspect 25, wherein the assigned corresponding quality score indicates a probability of each geometric information of the plurality of geometric information associated with the target entity or a confidence of each geometric information of the plurality of geometric information associated with the target entity.

Aspect 27: The method of any of aspects 17 through 26, further comprising: receiving, from the wireless device, capability information associated with the wireless device for sensing the target entity, wherein transmitting, to the wireless device, the control signaling comprising the configuration is based at least in part on receiving, from the wireless device, the capability information associated with the wireless device for sensing the target entity.

Aspect 28: The method of aspect 27, further comprising: transmitting, to the wireless device, a request message for the capability information associated with the wireless device for sensing the target entity, wherein receiving, from the wireless device, the capability information is based at least in part on transmitting, to the wireless device, the request message for the capability information associated with the wireless device for sensing the target entity.

Aspect 29: The method of any of aspects 17 through 28, further comprising: receiving, from the wireless device, an indication of one or more of one or more measurement values or assistance information associated with the target entity.

Aspect 30: The method of any of aspects 17 through 29, wherein the wireless device comprises a UE or a TRP.

Aspect 31: The method of any of aspects 17 through 30, wherein the network entity comprises a network entity comprising one or more of an LMF or an SnMF.

Aspect 32: The method of any of aspects 17 through 31, wherein the control signaling comprises an SIB, and the SIB comprises a posSIB or a senseSIB.

Aspect 33: A wireless device for wireless communications, comprising one or more memories storing processor-executable code, and one or more processors coupled with the one or more memories and individually or collectively operable to execute the code to cause the wireless device to perform a method of any of aspects 1 through 16.

Aspect 34: A wireless device for wireless communications, comprising at least one means for performing a method of any of aspects 1 through 16.

Aspect 35: A non-transitory computer-readable medium storing code for wireless communications, the code comprising instructions executable by one or more processors to perform a method of any of aspects 1 through 16.

Aspect 36: A network entity for wireless communications, comprising one or more memories storing processor-executable code, and one or more processors coupled with the one or more memories and individually or collectively operable to execute the code to cause the network entity to perform a method of any of aspects 17 through 32.

Aspect 37: A network entity for wireless communications, comprising at least one means for performing a method of any of aspects 17 through 32.

Aspect 38: A non-transitory computer-readable medium storing code for wireless communications, the code comprising instructions executable by one or more processors to perform a method of any of aspects 17 through 32.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive, from a network entity, control signaling comprising a configuration for sensing and reporting information of a target entity in a wireless communication system;
obtain geometric information associated with the target entity in the wireless communication system based at least in part on a radio frequency sensing procedure according to the configuration; and
transmit, to the network entity, a report including the geometric information associated with the target entity.

2. The wireless device of claim 1, wherein the one or more processors are individually or collectively further operable to execute the code to cause the wireless device to:
identify expected geometric information associated with the target entity based at least in part on the configuration, the expected geometric information comprising one or more of an expected shape associated with the target entity or an expected dimension associated with the target entity, wherein the radio frequency sensing procedure is based at least in part on the expected geometric information associated with the target entity.

3. The wireless device of claim 2, wherein:
the expected geometric information corresponds to at least one format of indicating one or more of the expected shape associated with the target entity or the expected dimension associated with the target entity; and
the expected geometric information comprises one or more of bounding box information or bounding sphere information indicative of one or more of the expected shape associated with the target entity or the expected dimension associated with the target entity.

4. The wireless device of claim 1, wherein the one or more processors are individually or collectively further operable to execute the code to cause the wireless device to:
identify resolution information for sensing the target entity based at least in part on the configuration, the resolution information comprises a preferred beam-range resolution indicating one or more of a preferred beam range or a preferred beam azimuth, wherein the radio frequency sensing procedure is based at least in part on the resolution information for sensing the target entity.

5. The wireless device of claim 1, wherein the one or more processors are individually or collectively further operable to execute the code to cause the wireless device to:
identify at least one report format of the report including the geometric information associated with the target entity based at least in part on the configuration, the report including the geometric information associated with the target entity is based at least in part on the at least one report format.

6. The wireless device of claim 1, wherein the one or more processors are individually or collectively further operable to execute the code to cause the wireless device to:
receive, from the network entity, a first request message for first geometric information associated with the target entity;
obtain the first geometric information associated with the target entity based at least in part on the radio frequency sensing procedure and a first set of parameters associated with the configuration; and
transmit, to the network entity, a first response message comprising the first geometric information associated with the target entity based at least in part on the first request message for the first geometric information associated with the target entity.

7. The wireless device of claim 6, wherein the one or more processors are individually or collectively further operable to execute the code to cause the wireless device to:
receive, from the network entity, a second request message for second geometric information associated with the target entity based at least in part on the first response message comprising the first geometric information associated with the target entity;
obtain the second geometric information associated with the target entity based at least in part on the radio frequency sensing procedure and a second set of parameters associated with the configuration, wherein the second set of parameters is different than the first set of parameters; and
transmit, to the network entity, a second response message comprising the second geometric information associated with the target entity based at least in part on the second request message for the second geometric information associated with the target entity.

8. The wireless device of claim 7, wherein the geometric information comprises one or more of the first geometric information associated with the target entity or the second geometric information associated with the target entity.

9. The wireless device of claim 1, wherein the one or more processors are individually or collectively further operable to execute the code to cause the wireless device to:
receive, from the network entity, the control signaling comprising a plurality of hypotheses configurations for sensing the target entity, wherein each hypothesis configuration of the plurality of hypotheses configurations for sensing the target entity comprises a set of parameters, and wherein the set of parameters indicates one or more of a sensing procedure for sensing the target entity, a center frequency associated with sensing the target entity, or a bandwidth associated with sensing the target entity;
obtain geometric information associated with the target entity based at least in part on the plurality of hypotheses configurations for sensing the target entity;
assign a corresponding quality score for each of the geometric information; and
transmit, to the network entity, the report comprising the geometric information associated with the target entity and the corresponding quality score for each of the geometric information.

10. The wireless device of claim 9, wherein the corresponding quality score indicates a probability of each of the geometric information associated with the target entity or a confidence of each of the geometric information associated with the target entity.

11. The wireless device of claim 1, wherein the one or more processors are individually or collectively further operable to execute the code to cause the wireless device to:
transmit, to the network entity, capability information associated with the wireless device for sensing the target entity,
wherein to receive, from the network entity, the control signaling comprising the configuration is based at least in part on transmitting, to the network entity, the capability information associated with the wireless device for sensing the target entity.

12. The wireless device of claim 11, wherein the one or more processors are individually or collectively further operable to execute the code to cause the wireless device to:
receive, from the network entity, a request message for the capability information associated with the wireless device for sensing the target entity,
wherein to transmit, to the network entity, the capability information is based at least in part on receiving, from the network entity, the request message for the capability information associated with the wireless device for sensing the target entity.

13. The wireless device of claim 1, wherein the one or more processors are individually or collectively further operable to execute the code to cause the wireless device to:
obtain one or more measurement values associated with the target entity based at least in part on the radio frequency sensing procedure;
determine assistance information based at least in part on the one or more measurement values associated with the target entity, wherein the assistance information comprises one or more of an expected shape associated with the target entity or an expected dimension associated with the target entity; and
transmit, to the network entity, an indication of at least one of the one or more measurement values or the assistance information associated with the target entity.

14. The wireless device of claim 1, wherein the wireless device comprises a user equipment (UE) or a transmission-reception point (TRP).

15. The wireless device of claim 1, wherein the network entity comprises a network entity comprising one or more of a location management function (LMF) or a sensing management function (SnMF).

16. The wireless device of claim 1, wherein the control signaling comprises a system information block (SIB), and wherein the SIB comprises a position SIB (posSIB) or a sensing SIB (senseSIB).

17. A network entity, comprising:
one or more memories storing processor-executable code; and
one or more processors coupled with the one or more memories and individually or collectively operable to execute the code to cause the network entity to:
transmit, to a wireless device, control signaling comprising a configuration for sensing and reporting information of a target entity in a wireless communication system; and
receive, from the wireless device, a report including geometric information associated with the target entity based at least in part on the configuration for sensing and reporting information of the target entity.

18. The network entity of claim 17, wherein:
the configuration identifies expected geometric information associated with the target entity, and
the expected geometric information comprises one or more of an expected shape associated with the target entity or an expected dimension associated with the target entity.

19. The network entity of claim 18, wherein:
the expected geometric information corresponds to at least one format of indicating one or more of the expected shape associated with the target entity or the expected dimension associated with the target entity, and
the expected geometric information comprises one or more of bounding box information or bounding sphere information indicative of one or more of the expected shape associated with the target entity or the expected dimension associated with the target entity.

20. A method for wireless communications at a wireless device, comprising:
receiving, from a network entity, control signaling comprising a configuration for sensing and reporting information of a target entity in a wireless communication system;
obtaining geometric information associated with the target entity in the wireless communication system based at least in part on a radio frequency sensing procedure according to the configuration; and
transmitting, to the network entity, a report including the geometric information associated with the target entity.
